(19) United States
(12) Patent Application Publication
(10) Pub. No.: US 2024/0400427 A1
(43) Pub. Date: Dec. 5, 2024

(54) OXIDIZING COMPOSITIONS FOR REMOVING SULFUR COMPOUNDS FROM HYDROCARBON FUELS AND WASTEWATER

(71) Applicant: JDS Chemicals, LLC, Oologah, OK (US)

(72) Inventor: Robert Scott Decker, Joplin, MO (US)

(21) Appl. No.: 18/325,646

(22) Filed: May 30, 2023

(51) Int. Cl. C02F 1/76; C02F 1/68

(52) U.S. Cl. CPC C02F 1/763; C02F 1/683; C02F 2201/002; C02F 2209/04; C02F 2305/02

(57) ABSTRACT

An oxidizing composition for removing hydrogen sulfide (H₂S) from a gaseous or liquid stream includes mixture products of water, sodium hypochlorite, a chelating agent, and a transition metal compound. The chelating agent can be etidronic acid; the transition metal compound can be an iron (III) compound, such as ferric sulfate. The oxidizing composition is formed by (i) combining water, chelating agent, and transition metal compound to form an activator composition and (ii) mixing the activator composition with a sodium hypochlorite solution to adjust the pH, such as for a particular use. Some embodiments include various apparatuses and methods for treating different treatment sites with the oxidizing compositions disclosed herein. Examples of suitable treatment sites include, without limitation, natural gas pipelines, bubble towers, oil wells, gas wells, sewer wet wells, air scrubbers, saltwater disposal pipelines, and saltwater disposal wells.

### BACKGROUND

Natural gas is an abundant and important energy source used for a variety of purposes. Natural gas typically contains gaseous lower alkanes, primarily methane with lesser amounts of ethane, propane, butane. A major problem that affects many natural gas resources is the inclusion of sulfur-based compounds, primarily hydrogen sulfide gas (H₂S), along with the alkanes, yielding “sour gas”. Natural gas is usually considered “sour” if there are more than 5.7 milligrams of H₂S per cubic meter of natural gas, which is equivalent to approximately 4 ppm under standard temperature and pressure.

Other hydrocarbon fuels, such as diesel and naphtha, may contain H₂S and other sulfur compounds, which diminishes their value as fuels because of oxidized sulfur emissions.

H₂S is highly toxic and can cause serious injury and death at relatively low concentrations. Besides high toxicity, H₂S is very corrosive to pipelines and must be removed to produce usable natural gas. Before raw natural gas containing hydrogen sulfide can be used, the raw gas must be treated to remove sulfur to acceptable levels.

The removal of H₂S is referred to as “sweetening”, and the sweetened product lacks the sour, foul odor of hydrogen sulfide. The removed H₂S can be converted to elemental sulfur in a Claus process or a liquid redox process, and/or it can be treated in a wet sulfuric acid process unit to produce sulfuric acid. Alternatively, highly H₂S concentrated gas can be recompressed by gas compressor units designed to handle highly toxic and corrosive gas and injected back into the natural gas reservoir.

The Claus process (named after Carl Friedrich Claus) is an important sulfur recovery process in the industry, recovering elemental sulfur from gaseous H₂S. The Claus process recovers elemental sulfur from an acid gas stream through partial oxidation of the H₂S to SO₂ and then to sulfur. Typically, the Claus process works along with an acid gas removal system, which removes H₂S from the sour gas stream. The resulting acid gas stream which generally contains hydrogen sulfide, carbon dioxide and moisture can be treated through a Claus unit. In general, the natural gas stream, or syngas stream containing hydrogen sulfide is not sent directly to a Claus plant, because the Claus plant will oxidize the valuable natural gas. Rather, a Claus plant is typically used to treat concentrated streams containing more than 50% H₂S. Typically, a Claus plant can remove 95-98% of the inlet sulfur. Thus, either a modified Claus process if performed or another H₂S removal process is performed upstream of the Claus process.

For example, the GT-SPOC (Sulphur Partial Oxidation Catalysis) process is a Claus-type process in which the burner and reaction furnace section is replaced by a catalytic section. The catalytic section is a short contact time reactor, with millisecond residence time. The catalytic section can operate with lean H₂S (<25% H₂S) and produces less carbonyl sulfide (COS), carbon disulfide (CS₂), and dissolved H₂S in the molten elemental sulfur.

Another example is the GT-DOS (Direct Oxidation to Sulfur) process, which converts H₂S catalytically directly into sulfur, from lean (low concentration) H₂S streams (0.2% to 40% H₂S). The sulfur conversion efficiency is approximately 90% in a single pass and can attain 95-98% overall conversion efficiency. The GT-DOS process is most commonly used for sulfur recovery from an acid gas stream from an Acid Gas Removal unit. In that configuration, the H₂S in the acid gas is partially oxidized directly to sulfur (without first producing SO₂, as in the Claus process). Unlike the Claus process, there is no burner and reaction furnace, which means the GT-DOS process can directly handle lean acid gas streams.

The Stretford process is a liquid-redox process and was the first liquid phase, oxidation process for converting H₂S into sulfur to gain widespread acceptance.

The LO-CAT process is also a liquid-redox process and is a wet scrubbing, liquid redox system that uses a chelated iron solution to convert H₂S to elemental sulfur. It does not use any toxic chemicals and does not produce any hazardous waste byproducts. The LO-CAT process can directly treat a gas stream, or treat the H₂S containing stream from an Acid Gas Removal unit, although the direct treat capability is limited to low pressure streams.

The SulFerox is a proprietary iron Redox process in which a sour gas stream containing H₂S is contacted with a liquid containing soluble ferric (Fe³⁺) ions. In the process, H₂S is oxidized to elemental sulfur and the ferric (Fe³⁺) ions are reduced to ferrous (Fe²⁺) ions. The system is regenerable, wherein the ferrous (Fe²⁺) ions are reconverted to ferric (Fe³⁺) ions by oxidation with air. Sulfur is recovered from the aqueous solution as a moist cake. The SulFerox process can directly treat a gas stream, or treat the H₂S-containing stream from an Acid Gas Removal unit, although the direct treat capability is limited to low pressure streams.

The Thiopaq O&G process integrates gas purification with sulfur recovery in a single unit. The sour feed gas first comes into contact with a lean solution in the absorber. This solution absorbs H₂S to form sodium sulfides, and sweet gas exits the absorber, ready for use or further processing. The process uses naturally occurring bacteria (Thiobacillus) to oxidize H₂S to elemental sulfur.

The CrystaSulf process can be used to remove H₂S from high-pressure gas. It uses a nonaqueous solution with a high solubility for elemental sulfur. Because the elemental sulfur stays dissolved in the solution, there are no solids in the liquid circulated to the absorber. By design, CrystaSulf avoids the problems that make the aqueous sulfur recovery systems unsuitable for direct treatment of high-pressure sour gas.

Another issue is that H₂S is very corrosive to natural gas and other pipelines. Existing methods for removing H₂S from sour gas do not treat corrosion and scaling, apart from reducing exposure to H₂S, which only indirectly reduces corrosion and scaling.

As is readily apparent, there are several different processes for removing H₂S from sour gas, each having its own unique advantages and shortcomings, such as high expense, being a complicated multi-step process, production of high quantities of effluent, and use of expensive catalysts, among other things. Accordingly, there remains a need to find more efficient ways for removing H₂S from sour gas, other hydrocarbon fuels such as naphtha, and waste streams that contain H₂S or other sulfur compounds. In addition, it would be advantageous if the process of removing H₂S from a pipeline or other processing equipment also provided long-term protection against corrosion and scaling of the exposed metal surfaces.

### SUMMARY

Disclosed herein are activated oxidizing compositions for use in removing H₂S from sour gas streams, such as within or from a wellbore or a natural gas delivery line. Also disclosed are activated oxidizing compositions for use in processes that remove H₂S and other sulfur compounds from other hydrocarbon fuels, such as diesel and naphtha, and wastewater, such as municipal sewer lines or wastewater produced when treating sour gas to remove H₂S. Also disclosed are activated oxidizing compositions for use in cleaning pipelines and to provide anti-scaling and anti-corrosion effects.

The activated oxidizing compositions used to remove H₂S and other sulfur compounds from sour gas streams, other hydrocarbon fuels, and wastewater, or to clean pipelines and provide anti-scaling and anti-corrosion effects, are based on similar chemistry. The activated oxidizing compositions comprise an aqueous mixture of sodium hypochlorite (the primary source of oxidizing components), a chelating agent (e.g., etidronic acid), and one or more transition metal compounds (e.g., one more iron-based compounds). Different activated oxidizing compositions used for the various purposes may differ in pH, which is a function of the relative amounts of the various components in the composition, as will be explained below. The activated oxidizing compositions may also differ in physical form and/or stability.

In some embodiments, activated oxidizing compositions for treating sour gas, other hydrocarbon fuels, or wastewater streams to remove sulfur compounds or to clean and treat pipelines are made by first preparing an activator composition comprising an aqueous mixture of chelating agent and one or more transition metal compounds. Thereafter, the activator composition is combined with an aqueous sodium hypochlorite solution to form an activated oxidizing composition that effectively and efficiently oxidizes H₂S to elemental sulfur, which can be removed using known means (e.g., filtration of aqueous effluent). The transition metal compound, in addition to participating in reactions that activate the sodium hypochlorite to remove H₂S, is believed to impart anti-corrosion and anti-scaling protection to pipelines and other equipment.

The activated activator composition is acidic, with a pH of less than 7, typically less than 6, 5 or 4 depending on the concentration of the various components. Aqueous sodium hypochlorite (NaOCl) is basic, with a pH between about 11-13 depending on whether the composition contains a stoichiometric excess of sodium hydroxide (NaOH). A typical sodium hypochlorite solution has a pH between about 11.85 about 13, corresponding to approximately 0.25% to 0.35% excess sodium hydroxide. The pH of activated oxidizing compositions for use in removing sulfur compounds from gas or liquid streams can be adjusted by changing the relative amounts of the activator composition and sodium hypochlorite solution.

In some embodiments, the activator composition is added to the sodium hypochlorite solution in order to lower an initially high pH to a desired lower pH. Because combining the acidic activator solution and basic sodium hypochlorite solution is exothermic, it is advantageous to continuously stir the sodium hypochlorite solution while adding the activator composition to avoid local heat pockets and gas formation and overcome the buffering effects of sodium hypochlorite to arrive at the desired pH without overshooting the mark. In some cases, the pH of the mixed composition continues to drop from an initial value. Thus, care must be taken to allow the pH to reach equilibrium rather than continue to add activator composition until the desired pH is achieved.

In some embodiments, activated oxidizing compositions used to clean sour gas, other hydrocarbon fuels, and wastewater are made by first forming an activator composition by mixing a chelating agent, such as etidronic acid, and a transition metal compound, such as ferric (Fe³⁺) sulfate, with water to form an aqueous activator composition. The activator composition is then added to an aqueous sodium hypochlorite solution (e.g., 15% solution) to form the activated oxidizing composition. The activated oxidizing compositions used to clean sour gas preferably have a pH in a range of about 9.8 to about 10.5, preferably about 10 to about 10.3, with a pH of about 10.2 being more preferred. Thus, a quantity of activator composition is added to the high pH sodium hypochlorite solution until the oxidizing composition has been adjusted to a desired pH. The activated oxidizing removal composition is preferably used within a few hours or days of mixing to remove H₂S from sour gas, preferably by injecting an atomized spray into a gas pipeline or borehole.

In some embodiments, activated oxidizing compositions used to clean wastewater, such as municipal sewer water and wastewater from cleaning sour gas, are made in a similar manner but by adding an additional quantity of the activator composition in order to further lower and adjust the pH to a range of about 9.0 to about 10.1, preferably about 9.6 to about 10, more preferably about 9.7.

In some embodiments, activated oxidizing compositions used to clean pipelines and provide anti-scaling and anti-corrosion effects are made in a similar manner but by adding an additional quantity of the activator composition in order to further lower and adjust the pH to a range of about 8 to about 9.8, preferably about 8.5 to about 9.5, more preferably about 8.8 to about 9.4.

In some embodiments, activated oxidizing compositions used to clean other hydrocarbon fuels or oil products, such as diesel fuel and naphtha, are made in a similar manner as those used to treat sour gas and wastewater. When treating naphtha, for example, the pH is less important and works across a broad range. However, it has been found to be advantageous to increase the concentration of the transition metal compound somewhat.

Some embodiments include various apparatuses and methods for treating different treatment sites with the oxidizing compositions disclosed herein. Examples of suitable treatment sites include, without limitation, natural gas pipelines, bubble towers, oil wells, gas wells, sewer wet wells, air scrubbers, saltwater disposal pipelines, and saltwater disposal wells.

Additional features and advantages will be set forth in part in the description that follows, and in part will be obvious from the description, or may be learned by practice of the embodiments disclosed herein. It is to be understood that both the foregoing brief summary and the following detailed description are exemplary and explanatory only and are not restrictive of the embodiments disclosed herein or as claimed.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a first apparatus for using the oxidizing composition described and claimed herein;

FIG. 2 is a block diagram of one specific embodiment of the system controller shown in FIG. 1;

FIG. 3 is a block diagram of the chemical control application shown in FIG. 2;

FIG. 4 is a flow diagram of a first method for using the oxidizing composition that could be used with the apparatus of FIG. 1;

FIG. 5 is a block diagram of a prior art bubble tower;

FIG. 6 is a block diagram of a second apparatus for using the oxidizing composition in a bubble tower;

FIG. 7 is a flow diagram of a second method for using the oxidizing composition that could be used with the apparatus of FIG. 6;

FIG. 8 is a block diagram of a third apparatus for using the oxidizing composition to treat an oil or gas well;

FIG. 9 is a flow diagram of a third method for using the oxidizing composition that could be used with the apparatus of FIG. 8;

FIG. 10 is a block diagram of a fourth apparatus for using the oxidizing composition to treat sewage;

FIG. 11 is a flow diagram of a fourth method for using the oxidizing composition that could be used with the apparatus of FIG. 10;

FIG. 12 is a block diagram of a prior art packed air scrubber;

FIG. 13 is a block diagram of a fifth apparatus for using the oxidizing composition to air at the inlet to a packed air scrubber;

FIG. 14 is a flow diagram of a method for preparing a packed air scrubber to use the oxidizing composition;

FIG. 15 is a flow diagram of a fifth method for using the oxidizing composition that could be used with the apparatus of FIG. 13;

FIG. 16 is a block diagram of a sixth apparatus for using the oxidizing composition to tread a saltwater disposal (SWD) well;

FIG. 17 is a flow diagram of a sixth method for using the oxidizing composition that could be used with the apparatus of FIG. 16;

FIG. 18 is a block diagram of a seventh apparatus for using the oxidizing composition to tread a saltwater disposal (SWD) well; and

FIG. 19 is a flow diagram of a seventh method for using the oxidizing composition that could be used with the apparatus of FIG. 18.

### DETAILED DESCRIPTION

### Introduction

Disclosed herein are activated oxidizing compositions for removing H₂S and other sulfur compounds from sour gas streams, such as within or from a wellbore or a natural gas delivery line. Also disclosed are activated oxidizing compositions for removing H₂S and other sulfur compounds from other hydrocarbon fuels, such as diesel and naphtha, and wastewater, such as municipal sewer lines or wastewater produced when treating sour gas to remove H₂S. Also disclosed are activated oxidizing compositions for cleaning pipelines and providing anti-scaling and anti-corrosion effects.

The activated oxidizing compositions used to remove H₂S and other sulfur compounds from sour gas streams, other hydrocarbon fuels, and wastewater, and to clean pipelines and provide anti-scaling and anti-corrosion effects, comprise a mixture of aqueous sodium hypochlorite (oxidizing agent), a chelating agent (e.g., etidronic acid), and one or more transition metal compounds (e.g., iron compounds, such as ferric sulfate). The activated oxidizing compositions mainly differ in pH depending on use.

By way of background, the removal of H₂S and other sulfur compounds from sour gas streams, other hydrocarbon fuels, and wastewater, and cleaning of pipelines generally, involves strong oxidizing compositions that oxidize sulfur anions to elemental sulfur, which can be readily separated from the gas, liquid fuel, wastewater stream, or pipeline being treated and collected by known means, such as by filtering an aqueous slurry to form a filter cake.

There is a powerful reaction that produces several strong oxidative compounds, such as hydroxyl radicals, that can be used in “advanced oxidation” processes. For example, Fenton reagents or Fenton reactions can create oxidizing compounds from hydrogen peroxide (H₂O₂) or ozone (O₃). Traditionally, Fenton reagents are created in acidic pH ranges in order to be efficient and effective. Examples include ozone and ultraviolet (UV) light, ozone and hydrogen peroxide (H₂O₂) at low pH, H₂O₂ and UV light, ferrous (Fe²⁺) ions, H₂O₂, and UV light in a low pH environment, and the like. The combination of these compounds, especially with iron (Fe) compounds is known to produce hydroxyl radicals that are extremely reactive and can quickly break down compounds that are not as easily attacked by the strong oxidants individually that are used in the process. Hydroxyl radical formation is difficult to maintain or control but has become less unpredictable the past few decades as people have gained more experience with the process. Hydroxyl radical formation typically involves an acid reaction at low pH.

Recently, some companies have claimed they can produce modified Fenton reactions using various other oxidizers and with creative names to protect what they are doing from general knowledge. There is one study from overseas that mentions some success in mixing iron into wastewater, and then adding chlorine in order to reduce chemical oxygen demand (COD) in hard to treat municipal or industrial wastewater streams. This same approach has been less effective, however, on biological oxygen demand (BOD), and the study laments that achieving proper ratios is difficult and using too much may lessen the desired effects.

Another approach is to use caustic aqueous sodium hypochlorite by itself to treat wastewater without premixing with other components. However, the use of aqueous sodium hypochlorite has been found to be substantially inferior compared to the activated oxidizing compositions disclosed herein.

The inventor has 30 years of experience using strong oxidation technologies for a variety of purposes. These include using and generating ozone gas and its mass transfer to liquids in conjunction with H₂O₂ and also sodium and calcium hypochlorite as well as sulfuric acids. Over the years the inventor discovered and developed techniques to mix compounds that are not typically mixed together due to established known risks or undesirable reactions.

The activated oxidizing compositions disclosed herein are made with components that are generally understood to be incompatible with each other and should not be used in the manner disclosed. In particular, it is contrary to established norms and warnings to combine sodium hypochlorite with an acid and iron compound because doing so typically causes the generation and release of toxic gases. However, when mixed according to the present disclosure, the supposedly incompatible components do not in fact generate and emit significant quantities of toxic gases, but create effective activated oxidizing compositions, which is surprising and unexpected.

The invention disclosed herein involves a simple method to produce from supposedly incompatible components a reasonably stable and extremely effective activated oxidizing composition that exceeds any oxidation chemistry the inventor has used in his 30 years of experience. This includes being extremely efficient in oxidizing H₂S to elemental sulfur, even when used in very low amounts, which is a substantial improvement over known methods for removing H₂S and other sulfur compounds from sour gas, other hydrocarbon fuels, and wastewater. The chemistry does not rely exclusively on hydroxyl radical production, although it is reasonable to assume that some quantity of hydroxyl radicals are produced. The activated oxidizing compositions produce a wide range of oxidation and other reactions that synergistically produce a very powerful oxidizing composition for use in various treatments, including those disclosed herein.

### Activated Oxidizing Compositions

The activated oxidizing compositions disclosed herein are made by mixing aqueous sodium hypochlorite together with a chelating agent (e.g., etidronic acid) and a transition metal compound, such as an iron compound, to form a relatively stable and extremely aggressive activated oxidizing composition at a high pH (as compared to the currently accepted low pH Fenton reactions). The inventive activated oxidizing compositions are highly reactive when mixed into gaseous or liquid streams with an oxidative demand.

The activated oxidizing compositions destroy H₂S in gaseous and/or aqueous form and breaks up other sulfur compounds that can form H₂S in a liquid. By way of comparison, aqueous sodium hypochlorite is capable of oxidizing H₂S to elemental sulfur; however, the stoichiometric ratio typically ranges from 8-16 to 1. In contrast, the activated oxidizing compositions disclosed herein are effective at much lower stoichiometric ratios, which typically range from 1-3 to 1, when tested on municipal sewer collection systems within the liquid phase.

When used on a natural gas pipeline moving 2,375,000 cubic feet of gas per hour at 325 psi with a H₂S gas concentration of over 30 ppm, the H₂S was effectively removed in ten feet of pipe to concentrations of 0-4 ppm with an applied dosage of only 6 gallons of activated oxidizing composition per hour. In contrast, using 6 gallons of aqueous sodium hypochlorite by itself to treat 2,375,000 cubic feet of gas had zero effect-no significant amount of H₂S was removed.

The direct application of an atomized version of the activated oxidizing composition at very high pressure is able to contact and directly oxidize or absorb and oxidize the H₂S component of the gas stream with no diminishing effect on the rest of the gas or the pipeline. Not only do the activated oxidizing compositions not corrode the pipeline (though undiluted, the activator composition is extremely corrosive), they in fact protect the pipeline and reduce corrosion. The activated oxidizing composition and residual unreacted composition demonstrated an exceedingly strong cleaning or detergent effect within the pipeline, which removed built up contaminants and scale then protected the pipeline metals by acting as a barrier going forward.

The activated oxidizing compositions accomplish these things in the following ways. They break organic and chemical bonds very quickly through oxidation. In H₂S gaseous removal, the activated oxidizing compositions oxidize H₂S so quickly that its removal is completed within a matter of seconds and feet in a moving pipeline.

In addition, the activated oxidizing compositions break scales apart into their individual components. It is the inventor's experience, and is well documented in oceanographic studies, that many if not all naturally forming scales require a matrix around which to form. Such matrix is usually organic and exists as a result of mucinous compounds left over from microorganisms. The scale then forms layers by attaching to this organic compound and forming a structure, often in layers. The activated oxidizing compositions react with the scale and oxidize the organic material that the scale forms around. The material that formed the scale begins to rapidly fall away from the now destroyed matrix, and the combination of materials separates. Then what is oxidizable or reactive within the residue then goes through any remaining transformations until the fuel or the residual chemical (or newly formed chemicals) are exhausted. Many of the compounds of the activated oxidizing composition when produced are reactive in a water or wastewater environment. These have predictable benefits, but the unique combination of this chemistry consistently expedites those reactions.

It has been observed that the benefits provided by the various components in the activated oxidizing composition are not diminished by being mixed together but rather are enhanced. The anti-scale, de-scaling and anti-corrosion properties of the chelating agent benefit from the oxidizing species, which quickly penetrate and reach the bottom of existing contaminant layers in the pipeline. The reactions lift materials and allow the chelating agent to form a protective layer on the system metal. The strength of oxidation also reduces the rate of corrosion by forming an oxide layer on some system metal that is then resistant to further attack.

The transition metal compound (e.g., iron compound) is necessary to form the catalytic effect that significantly increases the speed of oxidation, either by aiding in the production of higher oxidative species or by catalytic effect as seen by other metal coated materials such as magnesium and aluminums.

Specifically within oil and dirt-contaminated liquid wastes in oil and gas fields, the iron compound, such as iron sulfate, has a demonstratable use in separation of emulsions via oxidation of weak chemical bonds that otherwise maintain emulsion stability. The presence of such strong oxidation chemistries show rapid separation of oil, minerals, and water.

### Activator Composition

The activator composition comprises an aqueous mixture of water, chelating agent, and transition metal compound.

The chelating agent provides various functions, as discussed herein, including stabilizing the transition metal compound and the resulting activated oxidizing composition. Examples of chelating agent that can be used herein include, but are not limited to, etidronic acid (also known as 1-hydroxyethylidene-1,1-diphosphonic acid and HEDP), ethylenediaminetetraacetic acid (EDTA), EDTA salts (e.g., sodium salts, such as mono-, di-, tri-, and tetrasodium salts), hydroxyethylethylenediaminetriacetic acid (HEDTA), HEDTA salts (e.g., trisodium salt of HEDTA, such as Versonal 120), ethylenediamine, amino acids, peptides, proteins, sugars, polysaccharides, citric acid, citrate salts, polyvalent carboxylic acids, salts of polyvalent carboxylic acids, and polynucleic acids. Etidronic acid is currently the preferred chelating agent, although it is believed that EDTA salts and Versonal 120 would also be effective chelating agents.

The transition metal compound provides various functions, as discussed herein, including forming an activator composition with the chelating agent in order to form powerful oxidation species when mixed with sodium hypochlorite and providing anti-corrosion and anti-scaling effects. Examples of preferred transition metal compounds include iron compounds, more preferably iron (III) compounds, and most preferably ferric sulfate.

In some embodiments, the activator composition, before being mixed with the sodium hypochlorite solution, includes the chelating agent at a concentration in a range of about 10% to about 25%, or about 12% to about 20%, or about 14% to about 18%. In some embodiments, the activator composition, before being mixed with the sodium hypochlorite solution, includes the transition metal compound at a concentration in a range of about 0.5% to about 5%, or about 0.75% to about 3%, or about 1% to about 2%.

### Sodium Hypochlorite Solutions

The sodium hypochlorite solutions that are mixed with the activator composition to form activated oxidation compositions as discloses can have any desired concentration, such as about 0.1% to about 20%, preferably about 5% to about 17.5%, more preferably about 10% to about 16%, and most preferably about 12% to about 15%, such as 15%.

### Method of Making Activated Oxidation Compositions

Although the activated oxidizing compositions disclosed herein can be safely made, handled, and used without significant release of toxic gases, care must be taken when producing the mixture to avoid formation of toxic gases and due to the warnings against mixing of these components.

Initially, it has been found to be undesirable to produce a composition possessing too much strength that may result in a runaway reaction. One way to avoid runaway reactions is to produce reasonable, rather than excessive, quantities of the composition, such as making less than tote-quantity batches. The activated oxidizing compositions can be produced in larger quantities but it may take a longer time to do so safely. Therefore, separately producing several tote quantities at once is safer and faster than making one large quantity. Thus, it has been found that 260-300 gallon (984-1,136 liter) tote quantities are the fastest and safest to produce.

A first step includes mixing a sodium hypochlorite solution within a tank or tote and keeping it moving (e.g., recirculating) preparatory to adding the activator composition. There may be a benefit in mixing a small amount of calcium hypochlorite into the sodium hypochlorite solution, but this has not yet been definitively proven.

Another step includes preparing a mixture of activator ingredients in water (e.g., 20% mixture of activator components), which is preferably deionized water and/or water treated by reverse osmosis (RO). By way of example, a 20% mixture preferably includes at least 18% acid (from the chelating agent), such as etidronic acid (HEDP), Versonol 120, or other effective chelating agent, preferably HEDP, and up to 2% of a pre-diluted ferric sulfate solution (e.g., diluted with water from 50% stock solution to 8%).

Once the sodium hypochlorite solution has been produced in desired quantities, a relatively small chemical injection pump can be utilized to begin slowly adding the activator solution into the recirculating main sodium hypochlorite solution. It is beneficial to keep the sodium hypochlorite solution agitated smoothly but not violently. One currently preferred method is to keep the sodium hypochlorite solution flowing during addition of the activator composition, which appears to be safer and produces little to no heat rise in the resulting mixed solution.

As the activator composition is added in small amounts to the flowing sodium hypochlorite solution, there will be a color change followed by a sudden drop in the whole batch pH. This pH drop is typically delayed because the sodium hypochlorite acts as a buffer that resists pH change, particularly since it constitutes the bulk of the mixture. However, over time once enough of the activator composition has been mixed in, the pH buffering effect will be overcome, and the pH will begin to drop. The final desired pH is dependent on the intended use of the activated oxidizing composition, as discussed herein.

For example, a product currently known as “SSH-100” is used for removing H₂S from sour gas, such as in natural gas pipelines and wellbores. To make SSH-100, a lesser amount of activator is added to adjust the pH to above 10.5, after which no more activator composition is added, or is slowly added, until the composition reaches an equilibrium pH between within a pH range of about 10-10.25. Mixing these ingredients to the point wherein the pH is stable within this range yields an activated oxidizing composition that gives the speed and power to destroy H₂S in either liquid streams or gaseous streams.

Another product is currently known as “EB-100”, which is used for cleaning pipelines and other equipment and to provide anti-scale and anti-corrosion properties. To make EB-100, a sufficient quantity of the activator composition is added to the sodium hypochlorite solution until the pH is adjusted to about 9.9, after which no more activator composition is added, or is slowly added, until the composition is allowed to reach an equilibrium pH between about 8.8 to 9.7. At this pH the proper mixture of ingredients produces the best results for cleaning and protecting pipelines and tanks.

SSH-100 and EB-100 have also been found to be useful in removing H₂S and other sulfur compounds from other hydrocarbon fuels, such as diesel and naphtha, and other oil products that contain sulfur compounds. This indicates that activated compositions across a broader pH work well for treating liquid hydrocarbons. Increasing the concentration of transition metal compound somewhat has been found to be helpful for treating liquid hydrocarbons.

A related product is currently known as “EB-50”, which is used as an emulsion breaker and is the strongest pipeline cleaning and provides the best anti-corrosion and anti-scaling barriers. This is made similar to EB-100, but has lower pH by continuing to add additional activator composition to the sodium hypochlorite solution until the pH is adjusted to between about 8 and 9.8, with a pH of 9.7 being very effective. Adjusting the pH to between 8.5 and 9.5 lessens the cleaning effect, but provides a superior barrier and descaling, which makes EB-50 well-suited for pipelines or other equipment that is already reasonably clean.

When used to treat sour gas via atomization, providing an activated oxidizing composition with a pH in a range of about 10-10.25 has been shown to be the most effective composition. If the pH is above or below this range, the H₂S concentrations can rapidly increase and the treatment may fail. The application of an atomized spray of this particular mixture is dependent on speed and absorption. When the pH is out of this range, the correct mixture of ingredients is not obtained to produce the strength or speed, such as the rate of absorption.

Another important variable is temperature. The reduction of H₂S is a speed dependent reaction and temperature greatly affects reaction speed. For atomization to remove H₂S, the best results are achieved at a liquid composition temperature above about 65° F. (18° C.) and below about 100° F. (38° C.). When the temperature is less than 65° F. (18° C.), the reaction is slowed down, with diminished results. When the temperature is greater than 100° F. (38° C.), the activated oxidizing composition can degrade and cause rapid off-gassing of chlorine, thus weakening the composition, which can lead to it eventually failing. When the temperature is too low, the oxidizing activity of the composition is weakened, and more of the composition is required to work properly at below 65° F. (18° C.) down to freezing.

The components of the activated oxidizing composition can be aggressive toward metals; however, once diluted into an environment with an oxidative demand, the composition unexpectedly and unpredictably behaves in the opposite manner and actually protects system metals. In order to pump or handle the activated oxidizing composition under pressure prior to its release in the treatment environment, it is preferable to use specially coated Hastelloy, titanium, and 316 SS fittings. The 316 SS fittings are otherwise destroyed without an applied coating, which can be a mixture of Teflon and ceramic. The Hastelloy also benefits from this coating. Without the protective coating, the activated oxidizing composition can eat through and destroy the fittings and connections within a matter of a few days and can plug or corrode the application plumbing, rendering it useless in a short time. There currently are no other known protective coatings that are compatible with the activated oxidizing composition.

In summary, the activated oxidizing composition, when mixed properly with due care and respect to its dangers if improperly prepared, forms a reasonably stable final product that can remain active for several weeks. When exposed to a reactive demand, the activated oxidizing composition contains numerous strong oxidative compounds, among which are chlorine compounds, hypochlorous acids, oxygen species, and other higher oxidative state compounds that work synergistically to speed the oxidation of compounds that would normally require additional time and amounts of oxidizing agent. The composition wipes out bacteria counts and biofilms that protect bacteria, exposing the system metal to the protective layers produced. Compounds such as scales and emulsions appear to be attacked at the bonds that hold them together. And this can be achieved at a very high rate of speed using a mixture of chemicals that established science says should never be mixed together.

It is important to realize that adding the activator composition to lower the pH of the sodium hypochlorite composition can release some amount of chlorine gas and possibly some hydrogen. Thus, mixing should be performed in a well-ventilated area while using protective gear for breathing, eyes, and hands.

In addition, the temperature of the product should be frequently checked as the components are being mixed. If there is a significant temperature rise or visible gas leaving the product, additional activator composition should not be added until the temperature goes down and there is no visible gas leaving the product.

It has been found that the product is the most reactive and possibly dangerous when mixed rapidly in small amounts of 10 gallons (38 liters) or less, down to 20 mL (0.68 oz). This is mostly due to adding the activator too quickly without keeping the liquid moving. A rapid runaway reaction can occur by mixing too rapidly. Also, a runaway reaction can occur when there is too much energy available for the reaction, as in the case of making large quantities, e.g., more than 300 gallons (1,136 liters).

The reaction can become highly unstable and become exothermic and volatile very quickly with very small amounts of the activator chemistry. Thus, it is desirable to only prepare the activated oxidizing composition in 260 gallon (984 liter) or 300 gallon (1,136 liter) tote quantities. These amounts have been found to be the most forgiving to the mixing and reacting process. Nonetheless, caution still must be used because the chemical can release chorine and other oxidants of volatile gases, but it is much slower and when done correctly over a small amount at a time with gentle movement there is no exothermic reaction and the product remains stable. After the mixed product has rested for several hours to overnight, it will remain stable for many weeks, only very slowly losing some strength after about two weeks but still remaining very strong and useful.

Etidronic acid is the preferred chelating agent and works the best. Versonal 120 and many other chelating agents can be used to produce the activator composition, but they require from 4 to 10 minutes to react with the sodium hypochlorite and produce the activated oxidizing composition. The chemical mixture will set during that time and then there will be a rise in temperature accompanied by a change in color and the sudden appearance of gas bubbles. This causes a rapid drop in pH to the range needed, and the chemical is ready. Therefore, care must be taken to stop adding activator composition at the correct pH with the expectation that it may release gas and the pH may drop again. There is a short window to use this mixture to get the strongest results. When using HEDP and the proper amount of ferric sulfate the activated oxidizing composition is ready as soon as the components are added together and the correct pH range has been attained. There is no need to provide a set amount of contact time. The reaction is stronger and requires less overall volume to achieve the results.

### Methods of Using Activated Oxidizing Compositions

In some embodiments, an appropriate activated oxidizing composition having the proper pH (e.g., SSH-100), as disclosed herein, is injected directly into gas pipelines in an atomized spray at pressures between 100-600 psi to remove H₂S gas from the natural gas and clean and protect the pipes.

In some embodiments, an appropriate activated oxidizing composition having the proper pH (e.g., EB-100), as disclosed herein, is added in liquid form to wastewater pipelines to clean, descale, and protect against corrosion. The activated oxidizing composition can also be used to remove H₂S or other sulfur-based compounds. For example, the activated oxidizing composition in very dilute form can be applied to municipal sewer collection systems to remove H₂S and protect infrastructure.

In some embodiments, SSH-100 and EB-100 can be blended in liquid form with a liquid hydrocarbon fuel, such as diesel or naphtha, or other oil product, to oxidize and remove H₂S and optionally other sulfur compounds.

Lastly, an activated oxidizing composition (e.g., EB-50) can be used as a down hole well treatment that cleans oil and gas wells. This destroys bacteria, lowers corrosion, and breaks down iron scales. It may break down barium and calcium scales as well. In a first 6-month trial, and within two weeks, the activated oxidizing composition was found to have opened up access points to gas and increased well gas production by over 20% without the wells being optimized or controlled properly for the larger capacity. Within two weeks of the end of the trial period, the gas levels returned to the lower flows. A new trial is planned to repeat the result on a dirty well pad. It is expected that this will restore gas production. The activated oxidizing composition is mixed and pressure injected down the backside of the well bore to the bottom of the well. In order to keep up with requirement, a new batch of activated oxidizing composition can be produced every few days, or as needed.

### EXAMPLES

The examples describe exemplary oxidizing compositions suitable for oxidizing H₂S to elemental sulfur while treating sour gas, other hydrocarbon fuels, and wastewater, cleaning pipelines, and proving anti-corrosion and anti-scaling effects.

### Example 1—Activator Composition

An aqueous activator composition for subsequent mixing with a sodium hypochlorite solution to form various activated oxidizing compositions suitable for removing H₂S and other sulfur compounds from natural gas pipelines, other hydrocarbon fuels, and wastewater and/or to provide anti-corrosion and anti-scaling properties, was made in multiple steps, including forming an etidronic acid solution and adding a diluted ferric sulfate solution to the etidronic acid solution to form the activator composition.

A 15 gallon (57 liter) drum of activator solution was prepared as follows. First, an initial etidronic acid mixture was made by mixing 3 gallons (11.3 liters) of etidronic acid into 8 gallons (30.3 liters) of water together with gentle mixing to avoid incorporating significant amounts of air into the water. Thereafter, an additional 3 gallons (11.3 liters) of water was added to the initial mixture to form the etidronic acid solution.

Second, a diluted ferric sulfate solution was made separately by mixing between 454.2 mL to 554.2 mL of concentrated ferric sulfate solution (50%) into 2 gallons (7.6 liters) of water together with gentle stirring to avoid incorporating significant amounts of air into the water. In general, the amount of concentrated ferric sulfate solution added to 2 gallons (7.6 liters) of water can be in a range of about 400 mL (13.5 oz) to about 600 mL (20.3 oz), or about 425 mL (14.4 oz) to about 575 mL (19.4 oz), depending on the desired activity of the activator solution. Using too little ferric sulfate solution in the activator solution can yield an unsafe mixture when added to a strong sodium hypochlorite solution (12-15%).

Then the diluted ferric sulfate solution (approximately 2 gallons (7.6 liters)) was slowly added to the etidronic acid solution, and immediately thereafter an additional quantity of water was added to produce 15 gallons (57 liters) of activator composition. This mixture was gently stirred or circulated for 30 seconds to 1 minute to avoid unnecessary air addition. It was found that the activator composition can be stored for 2-3 weeks without significant loss of potency. The drum was closed loosely and allowed to vent. After 1 hour, the lid was tightened up.

After 3 weeks, the activator composition was still effective but became less potent, requiring more of it to produce an activated oxidizing composition having the desired pH and oxidizing activity. Making larger quantities has been found to accelerate weakening of the activator composition.

### Example 2—SSH-100 Activated Oxidizing Composition for Removing H₂S from Gas Pipelines and Other Hydrocarbons

An activated oxidizing composition for removing H₂S from gas pipelines and other hydrocarbon fuels, such as diesel or naphtha (SSH-100) was made by slowly adding the activator composition of Example 1 to an aqueous sodium hypochlorite solution (15%) with constant stirring to adjust the pH to between about 10.10 to about 10.30, with a pH of about 10.2 working the best. It was found that there was a delay in pH reduction, meaning that the pH continued to drop after adding the activator composition to an aqueous sodium hypochlorite solution.

It was found that blending the activator on the fly with the 15% sodium hypochlorite solution produces the most active oxidizing composition. This is accomplished using a sophisticated pH controller with safeties and alarms to prevent mishap. The activated oxidizing composition can also be pre-mixed and remain stable for several weeks, although it appears to be somewhat less reactive than when the composition is mixed on the fly.

There is no wait time needed once the activated oxidizing composition has reached the required pH; it is ready to react with contaminants in the atomization, or in a pipeline or down hole. With the exception of atomization, pre-mixed SSH-100 is capable of working and will last after mixing up to 2 weeks.

The activated oxidizing composition was atomized and injected into a natural gas line to reduce H₂S to elemental sulfur, which was removed from the pipeline by known means. The stoichiometric ratio of activated sodium hypochlorite to H₂S was about 1-3:1.

The activated oxidizing composition was also used to remove H₂S from naphtha by treating 400 mL samples of naphtha with 1 mL of activated oxidizing composition. The activated oxidizing composition can also be used to treat other hydrocarbon fuels, such as diesel, and other oil products. Any oil product contaminated with H₂S can be treated using the activated oxidizing composition.

The best results are achieved when SSH-100 is produced on the fly, which yields the strongest and fastest acting oxidizing composition. It is also predicted that SSH-100 will likely prove to be highly effective in down hole applications, which will soon be tested on well pads. For this application, the pre-mixed version is believed to be the most suitable.

### Example 3—EB-100 Activated Oxidizing Composition for Removing H₂S from Wastewater and Liquid Hydrocarbons

An activated oxidizing composition (EB-100) for removing H₂S and other sulfur compounds from wastewater and liquid hydrocarbons was made by slowly adding the activator composition of Example 1 to an aqueous sodium hypochlorite solution (15%) with constant stirring to adjust the pH to between about 9.0 about 10.10. It was found that the amount of activator composition required to break the buffering effect of the sodium hypochlorite solution can vary with the age and strength of the activator composition.

It is important for the pH to be adjusted to the proper levels in order for the activated oxidizing composition to have the properties required to achieve the intended results. In addition, it does not only need to be at a specific pH but also requires the correct amount of the activator composition (both the etidronic acid and the mineral content) to cause the lowered pH. This pH is arrived at slowly and allowed to fall into the desired range then tweaked very slightly to reach the target pH.

The activated oxidizing composition was used for wastewater treatment of pipelines to prevent H₂S production and/or escape from the liquid when opening filters or pipes. The activated oxidizing composition oxidized H₂S and other sulfur compounds to elemental sulfur, which was removed from the wastewater by known means.

EB-100 is especially useful for use in saltwater disposal (SWD) pipelines and wells and other wastewater applications for removing the ability of the water to release or produce H₂S. This mixture is also a better pipeline cleaner and demulsifier compared to SSH-100. Applications well suited for using EB-100 are saltwater disposal pipelines, tanks, filters, and disposal wells. In addition, EB-100 is well suited for municipal wastewater sewage collection systems even though it contains diluted sodium hypochlorite (e.g., 1% to 2%).

EB-100 may also be suitable as an emulsion breaker, to treat landfill leachate and industrial streams requiring oxidation and biofilm destruction. EB-100 has also been used to treat naphtha to remove H₂S and other sulfur compounds.

### Example 4—EB-50 Activated Oxidizing Composition for Cleaning Pipelines

An activated oxidizing composition for use as an emulsion breaker and that was the strongest pipeline cleaner and provided the best anti-corrosion and anti-scaling effects (EB-50) was made by slowly adding the activator composition of Example 1 to an aqueous sodium hypochlorite solution (15%) with constant stirring to adjust the pH to within a range between 8 and 9.8, with a pH of 9.7 being very effective. Further reducing the pH lessens the cleaning effect but increases the barrier effect. So if the pipeline being treated is relatively clean, a pH of about 8.5-9.5 is a formidable product for providing good barrier and descaling effects.

The activated oxidizing composition was injected into a natural gas pipeline to clean the gas line and provide anti-corrosion and anti-scaling effects.

EB-50 is a good pipeline protector. EB-50 can be produced by reducing the pH below the pH levels best for EB-100. EB-50 is not as effective as EB-100 for removing H₂S but is a stronger pipeline protectant. It also demonstrates strong cleaning ability and scale destruction. All of the activated oxidizing compositions can remove and protect from scaling, but EB-50 is better because of the additional quantity of chelating agent required to lower the pH to below 9.9.

### Comparative Example A

A sodium hypochlorite solution having a concentration of 15% was used to remove H₂S from a natural gas pipeline. In order to be effective in oxidizing H₂S to elemental sulfur, the stoichiometric ratio of sodium hypochlorite to H₂S was between 8-16:1.

There is no comparison between a 15% sodium hypochlorite solution and the activated oxidizing composition made using 15% sodium hypochlorite solution. The speed and power of the new activated oxidizing composition are orders of magnitude faster and more complete than a 15% sodium hypochlorite solution when reacting with compounds and contaminants.

One test was performed using red dye. A 12-15% sodium hypochlorite solution takes 100 to 1000 times longer to clear red dye from a treated sample compared to the activated oxidizing compositions. A sodium hypochlorite solution, even at the correct pH for atomization, has little to no effect on H₂S content. Sodium hypochlorite solutions have no effect on hard scales but the activated oxidizing compositions do. Even though the activated oxidizing compositions are not acidic, they nonetheless are effective in destroying iron scales. They are also promising against barium scales and calcium scales and have a devastating effect on biofilms and biological materials.

### Detailed Use Cases for the Oxidizing Compositions

The disclosure above uses the term “activated oxidizing composition” to indicate the composition was activated by adding an activator to a sodium hypochlorite solution. For the discussion below, this is shortened to “oxidizing composition” for convenience.

The oxidizing compositions disclosed above may be used in a variety of different applications to provide a variety of different results and benefits. Several of these are presented below as “use cases” for the oxidizing compositions. Each use case will demonstrate both apparatus and methods for using the oxidizing compositions to achieve results that are far superior to any known oxidizing compositions in common use today in many different applications.

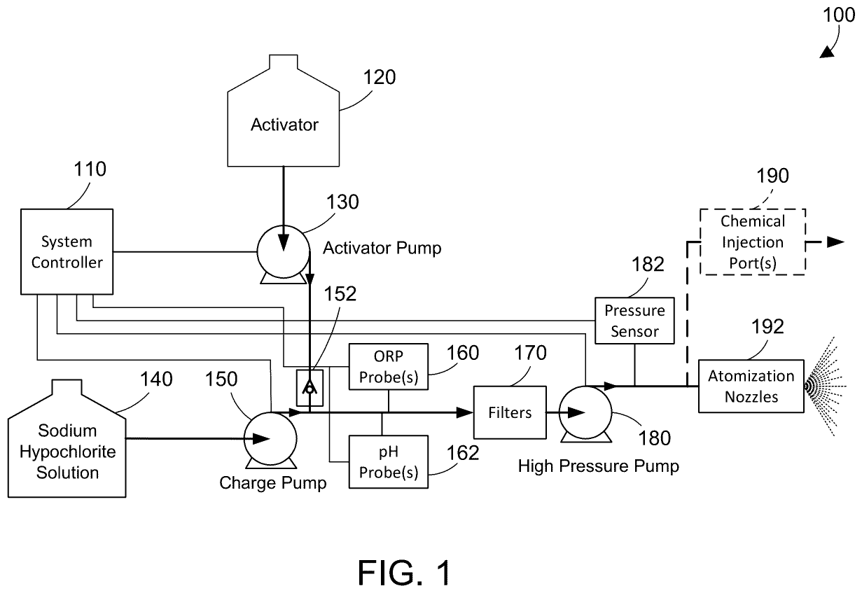

Referring to FIG. 1, an apparatus 100 that can be used in several different use cases includes a system controller 110, a tank 120 of activator, an activator pump 130, a tank 140 of sodium hypochlorite solution, a charge pump 150, a check valve 152, one or more Oxidizing Reduction Potential (ORP) probes 160, one or more pH probes 162, one or more filters 170, a high pressure pump 180, a pressure sensor 182, and one or more atomization nozzles 192. Some use cases don't require atomization nozzles 192, and such use cases could use one or more a chemical injection port(s) 190 shown in dotted lines in FIG. 1 instead of the atomization nozzles 192. The chemical injection ports 190 and atomization nozzles 192 broadly represent any way to deliver an oxidizing composition to a treatment site.

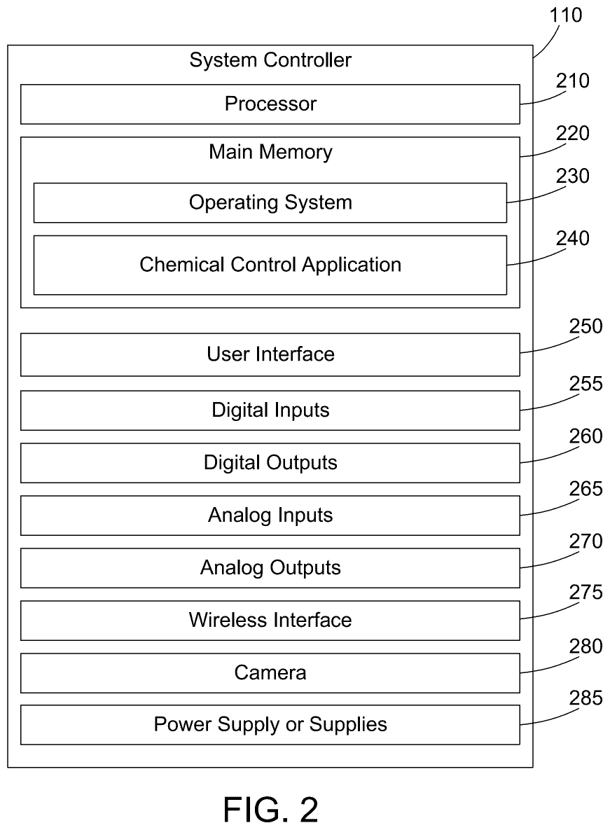

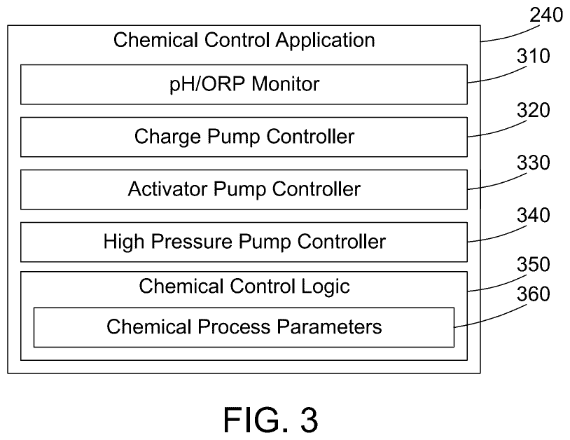

The system controller 110 is an electronic controller that receives inputs from the ORP probe(s) 160 and pH probe(s) 162, and provides output signals to drive the charge pump 150, activator pump 130, and high pressure pump 180. More details regarding the system controller are described below with reference to FIGS. 2-3. In one specific implementation, the system controller 110 is a Programmable Logic Controller (PLC), such as an Allen Bradley Micrologix series PLC or Automation direct Brix or Click series PLC. Of course, other implementations for the system controller 110 are also possible within the scope of the disclosure and claims herein.

The charge pump 150 pumps the sodium hypochlorite solution from tank 140 and outputs the sodium hypochlorite solution to a first pipe where the sodium hypochlorite solution is mixed with activator. The charge pump provides a pressure preferably in the range of 30-70 psi (210-480 Kilopascal (kPa)). The activator pump 130 pumps the activator from the tank 120 and injects the activator into the stream of sodium hypochlorite in the first pipe at the outlet of the charge pump. This injection of activator requires the output pressure of the activator pump 130 to be greater than the output pressure of the charge pump 150. The activator pump 130 preferably provides a pressure up to 100 psi (690 kPa), and is adjustable by varying the speed of the activator pump. The activator is provided from the activator pump 130 through a check valve 152 so the sodium hypochlorite from the charge pump cannot go up the line to the activator pump 130. The ORP probe(s) 160 and pH probe(s) 162 take their measurements in the first pipe after the activator has been injected into the sodium hypochlorite solution. The value(s) from the ORP probe(s) 160 and/or pH probe(s) 162 are used to tune and adjust the process. The pH value is suitably in the range of 9.9 to 10.7, is preferably in the range of 10.1 to 10.5, is more preferably in the range of 10.17 to 10.3, and is most preferably 10.2.

The multiple stages of filtration provided by filters 170 are needed to remove some of the intermediate materials that form after mixing the activator into the sodium hypochlorite solution, since what is most useful is the end product and not the intermediate materials that fall out of solution during the mixing and reaction of the sodium hypochlorite solution and the activator. The resulting chemical mixture after the filters 170 is one embodiment of the oxidizing composition disclosed herein. The high pressure pump 180 then provides this oxidizing composition at a higher pressure to one or more atomization nozzles 192, which provide a finely atomized spray of the oxidizing composition. The pressure sensor 182 provides a pressure input to the system controller 110, which can alter the speed of the high pressure pump 180 to keep the pressure at the atomization nozzles 192 in a desired range so the oxidizing composition is thoroughly atomized by the atomization nozzles 192. The preferred pressure at the atomization nozzles 192 is 50 to 200 psi (340-1400 kPa) greater than the pressure in the gas pipeline being treated, with 100 psi (690 kPa) over being the preferred pressure for the atomization nozzles. The temperature of the chemical being sprayed by the atomization nozzles is preferably 50-100 degrees Fahrenheit (10-38 degrees Celsius) with 60-70 degrees Fahrenheit (16-21 degrees Celsius) being preferred.

A block diagram showing possible features of the system controller 110 is shown in FIG. 2. The system controller preferably includes: a processor 210; a main memory 220; a user interface 250; digital inputs 255; digital outputs 260; analog inputs 265; analog outputs 270; a wireless interface 275; a camera 280; and one or more power supplies 285. The processor 210 provides the processing and control functions of the system controller 110. Processor 210 may be constructed from one or more microprocessors, microcontrollers, and/or integrated circuits, whether currently known or developed in the future. Processor 210 executes program instructions stored in main memory 220. Main memory 220 stores programs and data that processor 210 may access. When system controller 110 starts up, processor 210 initially executes the program instructions that make up operating system 230. Processor 210 also executes the chemical control application 240.

The chemical control application 240 is software that controls the function of the system controller 110 and the function of the various apparatuses disclosed herein. Additional details regarding the chemical control application are given below with reference to FIG. 3.

The user interface 250 can include any suitable input and output devices, including without limitation a keyboard, a mouse or other pointing device, a keypad, a display, audio alarms, knobs, etc. One suitable user interface that is commonly used on PLCs is a Human Machine Interface (HMI). The HMI allows a user to adjust parameters in the program and control the PLC. An HMI typically includes a touch screen that shows the control options and readings for the PLC and allow the user to control the PLC by interacting with the touch screen. The digital inputs 255 provide a digital interface for receiving input from any suitable digital device, such as a digital alarm from a sensor or other device. The digital outputs 260 can provide suitable digital outputs, including alarms, illumination of lights (including warning lights), control of valves or pumps, etc.

Analog inputs 265 allow receiving input from any suitable analog device, such as ORP probe(s) 160, pH probe(s) 162 and pressure sensor 182. Analog outputs 270 allow outputting analog signals to control aspects of the apparatus, such as activation and speed of the pumps 130, 150 and 180.

Wireless interface 275 can include any suitable interface that allows the system controller 110 to communicate with other external device, including without limitation, a Bluetooth interface, a Wi-Fi interface, and a cellular telephone interface. Camera 280 is preferably pointing to a portion of the apparatus that needs to be monitored and allows for real-time logging of events by the system controller 110. The power supply or supplies 285 can include one or more alternating current (AC) power supplies and/or one or more direct current (DC) power supplies. The power supply or supplies 285 preferably provide power not only to the system controller, but can also provide power to devices external to the system controller, such as the pumps 130, 150 and 180, the ORP probe(s) 160, and the pH probe(s) 162. In one specific embodiment, the system controller can control selective application of power from the power supply or supplies 285 to devices in the apparatus.

While many of the components shown in FIG. 2 are shown as part of the system controller 110, many of these components could be external to the system controller as well. The system controller disclosed herein expressly includes any suitable component as described or any suitable interface to an external component within the scope of the disclosure and claims herein.

Possible software modules that may be included of the chemical control application 240 are shown in FIG. 3 to include: a pH/ORP monitor 310; a charge pump controller 320; an activator pump controller 330, a high pressure pump controller 340; and chemical control logic 350 that controls the apparatus 100 according to specified chemical process parameters 360. The pH/ORP monitor 310 monitors the values received from the ORP probe(s) 160 and from the pH probe(s) 162. The charge pump controller 320 is a software module that allows activating and deactivating the charge pump 150. The activator pump controller 330 is a software module that allows activating and deactivating the activator pump 130, and additionally allows controlling the speed of the activator pump 130. The high pressure pump controller 340 is a software module that allows activating and deactivating the high pressure pump 180, and additionally allows controlling the speed of the high pressure pump 180.

The chemical control logic 350 includes logic that dictates how the chemical control application functions according to one or more specified chemical process parameters 360. The chemical control logic 350 allows the system controller 110 to control the apparatus 100 to achieve the desired functionality.

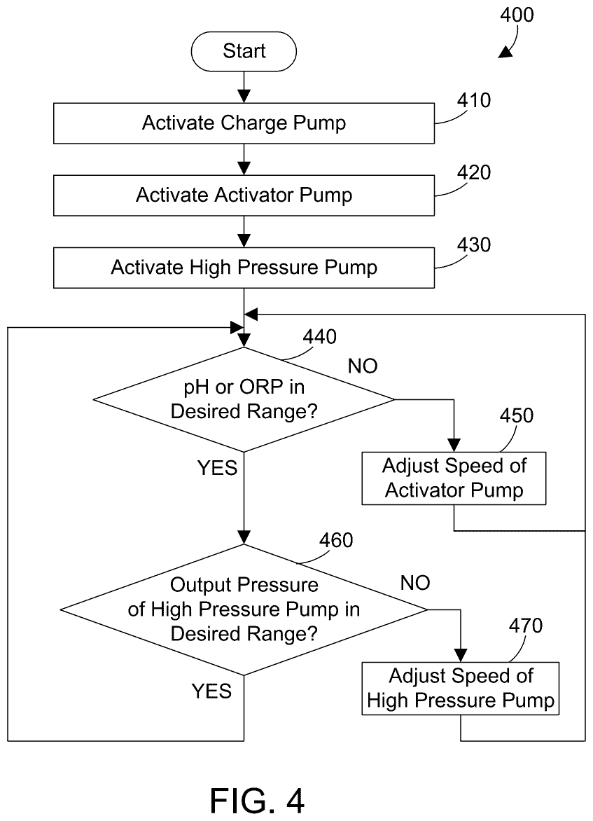

Referring to FIG. 4, a method 400 represents one suitable method that could be performed by the chemical control application 240 for the apparatus 100 in FIG. 1. The charge pump is activated (step 410). The activator pump is activated (step 420). The high pressure pump is activated (step 430). When the pH or ORP is not in the desired range (step 440=NO), the speed of the activator pump is adjusted (step 450) to add more or less activator to achieve the desired pH or ORP level. When the pH or ORP are in the desired range (step 440=YES), when the output pressure of the high pressure pump is not in a specified desired range (step 460=NO), adjust the speed of the high pressure pump (step 470). Thus, if the output pressure is too high, the speed of the high pressure pump is decreased; if the output pressure is too low, the speed of the high pressure pump is increased. Method 400 then loops back to step 440 and continues to monitor and adjust the speed of the activator pump and high pressure pump so the apparatus 100 functions as expected.

The apparatus 100 in FIG. 1 and method 400 in FIG. 4 are suitable for the use case of injecting the atomized oxidizing composition into a natural gas pipeline for real-time removal of H₂S as the gas flows through the pipeline and for pipeline cleaning and disinfection. Using the charge pump 150 to keep the mixed chemical under pressure prior to the high pressure pump 180 prevents gas that forms in the mixed chemical from air locking the high pressure pump 180. The types of pumps and materials for the pipes and fittings depends on the pipeline pressure. When the pipeline has a pressure less than 100 psi (690 kPa), the high pressure pump 180 can be an inexpensive chemical pump that provides up to 150 psi (1,000 kPa) and is made of plastic and is more resilient to the oxidizing composition, and the pipes and fittings can be made from a suitable plastic material such as polyvinyl chloride (PVC), Teflon, Kynar, PVDF, polypropylene, etc. Some plastics such as nylon and acetal are not compatible and will break down if used with the oxidizing compositions disclosed herein. Any suitable plastic can be used for pipes and fittings as long as the plastic is compatible, and therefore will not break down, when in contact with the oxidizing compositions disclosed herein.

When the pipeline has a pressure of 300 psi (2,000 kPa), the high pressure pump may need to provide a pressure in the range of 500-600 psi (3,400-4,100 kPa) to atomize the oxidizing composition. At these elevated pressures, the high pressure pump cannot be a plastic pump, but must instead be made of more expensive materials such as Hastelloy. In addition, the fittings must be Hastelloy or titanium to hold up to the effects of the oxidizing composition and to survive the higher operating pressure. The pressure of the high pressure pump is preferably 50-200 psi (340-1,360 kPa) over the pressure of the pipeline in which the atomization nozzles are installed.

Note the difference between a low pressure application and a high pressure application does not affect most of the system. Referring to FIG. 1, the difference in components between a low pressure application and a high pressure application is a different high pressure pump 180 and different tubing and fittings between the high pressure pump 180 and the atomization nozzles 192 or chemical injection port(s) 190 to survive the higher pressure. Suitable materials for the apparatus 100 include: 0.25 in to 0.375 in Teflon tubing with a stainless steel braid, rated at 250 psi (1,700 kPa); chemical push fittings of 0.25 in to 0.375 in, rated at 250 psi (1,700 kPa); a Hastelloy check valve available from TXAM Pumps as check valve 152; a chemical injection metering pump from Pulsafeeder as the activator pump 130; ORP probes 160 and/or pH probes 162 from Signet or Hach; a 12 VDC pump from Everflow such as the ESFW2200 as the charge pump 150; and atomization nozzles 182 that are plastic nozzles available from Tefen or Bete, or Spraying Solutions, or custom-manufactured titanium nozzles or Hastelloy nozzles available from Bete, or Spraying Solutions, or can be made by drilling and threading a Teflon rod. The high pressure pump 180 can be a lower pressure pump, such as a pump from LMI or Pulsafeeder, when the output pressure does not exceed 150 psi (1,000 kPa). The high pressure pump 180 is preferably a Hastelloy pump from TXAM Pumps, such as an HBT2-DC-1/2-SH-TVK-H pump, when the output pressure exceeds 200 psi (1,400 kPa).

One issue with apparatus 100 in FIG. 1 that provides an atomized spray of the oxidizing composition within a natural gas pipeline is how to get the atomized spray into the pipeline. It is known in the art to provide corrosion coupons in pipelines that can be used to determine the corrosive effects within the pipeline. A corrosion coupon is typically a rod of metal that has similar composition as the pipeline itself. A corrosion coupon is typically installed in a coupon holder that is installed on a pipeline, and the result is the corrosion coupon is exposed to the same environment as the interior of the pipeline. After some period of time passes, typically weeks or months, the corrosion coupon is removed and analyzed for loss of mass and pitting, which provides an indication of the corrosion on the interior of the gas pipeline.

The atomized spray of the oxidizing composition shown to the right of the atomization nozzles 192 in FIG. 1 can be provided by rebuilding coupon holders into chemical injection stingers. The coupon holder with a corrosion coupon is removed from the pipeline, and the corrosion coupon holder which is a 0.25 inch metal rod is removed and replaced with a 0.25 inch titanium tube with Hastelloy compression fittings on both ends. An atomization nozzle (one of 192 in FIG. 1) is attached to the in-pipeline end of the titanium tube via the compression fitting and the tubing from the outlet of the high pressure pump 180 is attached to the opposite end of the titanium tube. The coupon holder is then replaced in the pipeline, with the result of providing the atomized oxidizing composition within the pipeline to treat the natural gas as it travels down the pipeline. Of course, commercially-available chemical injections stingers could also be used, such as a Sentry SAF-T-VICE.

As discussed in detail above, SSH-100 is the preferred oxidizing composition for removal of H₂S from a natural gas pipeline. EB-100 is the preferred oxidizing composition for cleaning pipelines and providing anti-scale and anti-corrosion properties to a pipeline when reduction of H₂S is not the primary goal, but is still a useful benefit. EB-50 is the preferred oxidizing composition for cleaning pipelines and providing anti-scale and anti-corrosion properties to a pipeline when reduction of H₂S is relatively unimportant. Each of these three compositions have a different pH that makes each composition better suited to its specific intended use. The desired pH for a given application will be specified as one of the chemical process parameters 360 shown in FIG. 3 according to which of the three oxidizing compositions are selected for a particular use case.

An alternative to the system 100 in FIG. 1 within the scope of the disclosure and claims herein could use a pre-mixed chemical in the tank 140, with a sodium hypochlorite solution in the tank 120 that is injected into the pre-mixed chemical as needed to adjust the pH or ORP of the resulting mixture to a desired value or range. Over time the pH or ORP of the pre-mixed chemical can fall, so dynamically injecting the high-pH sodium hypochlorite solution that has a suitable pH of 12 or higher into the pre-mixed chemical is a way to boost the pH or ORP back up to the desired level or range. The term “pre-mixed chemical” as used herein means a mixture of sodium hypochlorite solution with activator such that a desired pH or ORP value or range is achieved depending on the specific use case for the pre-mixed chemical.

Because of the corrosive effects of the oxidizing compositions, the pressure sensors discussed above preferably have gauge protectors with membranes to prevent the sensors from being corroded by the oxidizing compositions.

The dosage of the oxidizing composition to achieve H₂S reduction in a gas pipeline according to the first use case depends on many factors. The concentration of H₂S, flow rate of the gas, liquid content and other pollutants are all variables that can change the amount of oxidizing composition needed. Field tests have shown the ability to reduce H₂S from 20-50 ppm down to 0-8 ppm in a gas pipeline by injecting three gallons per hour per 30 mmcf of gas.

In the first use case, the temperature of the oxidizing composition is preferably between 40-100 degrees Fahrenheit (4-38 degrees Celsius), and is more preferably in the range of 60-80 degrees Fahrenheit (16-27 degrees Celsius).

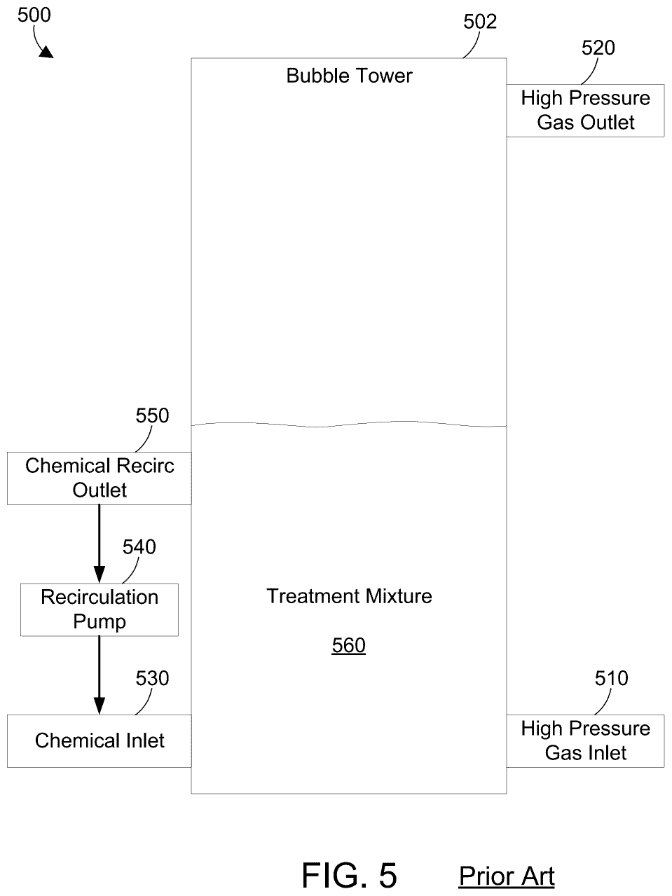

A second use case uses the oxidizing composition in a bubble tower. Referring to FIG. 5, a prior art bubble tower system is shown to provide context for the bubble tower use case. The bubble tower system 500 includes a bubble tower 502 that has a high pressure gas inlet 510 at the bottom of the tower and a high pressure gas outlet 520 at the top of the tower. The bottom portion of the tower 502 is filled with a treatment mixture 560, which is preferably an oxidizing (or scavenging) chemical that can remove H₂S from a stream of natural gas. A common oxidizing chemical often used in bubble towers for processing natural gas is triazine. Triazine is normally mixed with water in the bubble tower. While triazine is relatively effective at scavenging H₂S, the cost for cleaning H₂S from gas using triazine is significant and the resulting triazine waste is hazardous, making it difficult to dispose of. Waste triazine tends to coat disposal wells and tends to plug disposal wells, so many companies prefer not to deal with disposal of waste triazine.

The amount of treatment mixture 560 in the tower can vary according to the specific application and the degree of H₂S contamination in the incoming gas stream. A chemical inlet port 530 is towards the bottom of the tower 502 and a chemical recirculation outlet port 550 is towards a top of the treatment mixture 560. A recirculation pump 540 pumps chemical from the chemical recirculation outlet port 550 to the chemical inlet 530 to keep the treatment mixture 560 well-mixed. The gas entering the high pressure gas inlet port 510 bubbles up through the treatment mixture, which removes H₂S to an acceptable level. The gas above the treatment mixture 560 is treated gas, and is output through the high pressure gas outlet 520. The bubble tower 502 thus takes in sour gas, cleans the H₂S to an acceptable level, then outputs the cleaned gas.

Once the triazine loses its effectiveness over time by scavenging H₂S, the bubble tower 502 is drained, and the spent triazine liquid is hazardous waste that must be disposed of. New triazine and water is then added to the bubble tower 502, and the process can continue for the next batch. Some known bubble towers don't have a recirculation pump, but instead are run as a batch system. Such bubble towers are filled, and treatment of the gas continues until the H₂S rises to a level such that the triazine is spent and needs to be replaced. At this point the bubble tower is taken offline and the waste triazine is drained from the bubble tower. The bubble tower is then refilled and placed online, and the process then continues for the next batch using the new batch of triazine.

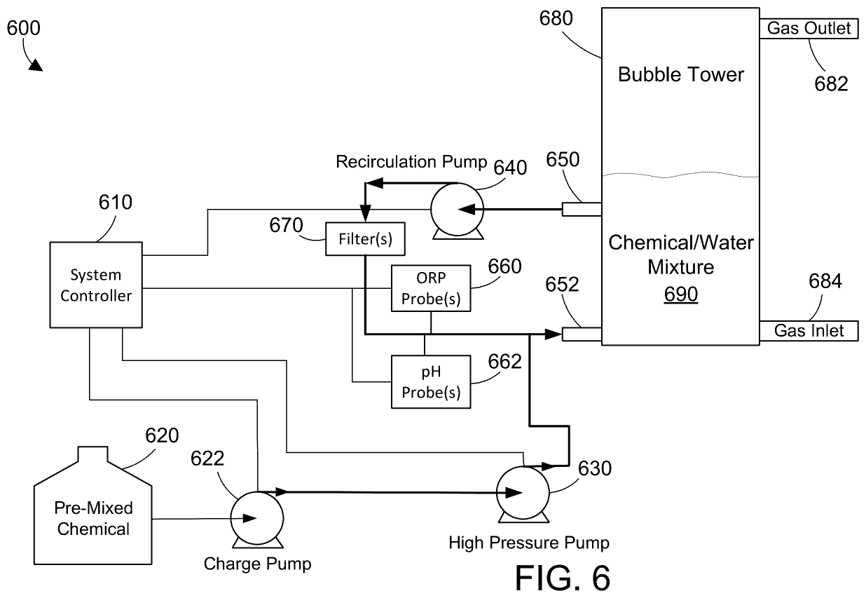

Referring to FIG. 6, a bubble tower system 600 is a second specific use case disclosed herein. The bubble tower system 600 includes a bubble tower 680 with a chemical/water mixture 690 where the chemical is an oxidizing composition as disclosed herein. Due to the extremely high oxidizing properties of the oxidizing compositions disclosed herein, the bubble tower 680 is preferably lined so the metal in the bubble tower is not exposed to the chemical/water mixture 690. Suitable linings include various plastics, including PVC, Teflon and Kynar, and can be permanently applied via spray adhesion to the interior of the tower or could be in a flexible film or pouch that lines the interior of the bubble tower 680.

The initial charge of the chemical/water mixture 690 is preferably a 50% mixture of the chemical, which is one of the oxidizing compositions herein, and 50% clean water, preferably water processed via reverse osmosis. The most preferred oxidizing composition (chemical) for the bubble tower system 600 is SSH-100. This makes sense because SSH-100 is the best of the three disclosed oxidizing compositions for removing H₂S from gas.

The bubble tower system 600 includes a recirculation pump 640 with its inlet connected to the chemical recirculation outlet port 650 on the bubble tower 680 and its output port coupled through one or more filters 670 to the chemical inlet port 652 on the bubble tower 680. The charge pump 622 pumps pre-mixed chemical from a tank 620 to the inlet of the high pressure pump 630. The charge pump 622 is still needed to maintain the inlet of the high pressure pump 630 under pressure so the gas in the pre-mixed chemical don't create a vapor lock on the high pressure pump 630. The outlet of the high pressure pump 630 is connected to the line from the filter(s) 670 that feeds into the chemical inlet port 652, thereby injecting the pre-mixed chemical into the stream going into the chemical inlet port 652 when the high pressure pump 630 is activated. One or more ORP probes 660 and pH probes 662 monitor the ORP and/or pH of the liquid being pumped by the recirculation pump 640 from the chemical circulation outlet port 650 through filter(s) 670. The system controller 610 controls the activation and deactivation of the recirculation pump 640 and the activation and deactivation of the high pressure pump 640. The activation and deactivation of the high pressure pump 630 is done by monitoring the pH or ORP of the chemical mixture, then turning the high pressure pump on and off to maintain a desired pH. For the bubble tower system 600 in FIG. 6, the pH is preferably 9.9 to 10.7, is more preferably 10.1 to 10.5, is most preferably 10.17 to 10.3, and is optimal at 10.2.

The bubble tower system 600 is a great improvement over the prior art bubble tower system 500 shown in FIG. 5 because bubble tower system 600 in FIG. 6 allows for dynamically adding more of the pre-mixed oxidizing composition into the chemical/water mixture 690 in the bubble tower 680. This allows the process to continue for a much longer time period than when triazine is used, which is typically done in a batch manner with the spent triazine having to be disposed of as hazardous waste. In addition, the cost of the oxidizing compositions disclosed herein is significantly less than the cost of triazine, resulting in significant cost savings while providing enhanced H₂S removal. Furthermore, when using the oxidizing compositions disclosed herein in a bubble tower, there will be no hazardous waste that must be disposed of. The spent oxidizing compositions in the bubble tower constitute dirty water that can be disposed of directly, such as in a saltwater disposal well, with no special treatment required because the spent oxidizing compositions are not hazardous waste.

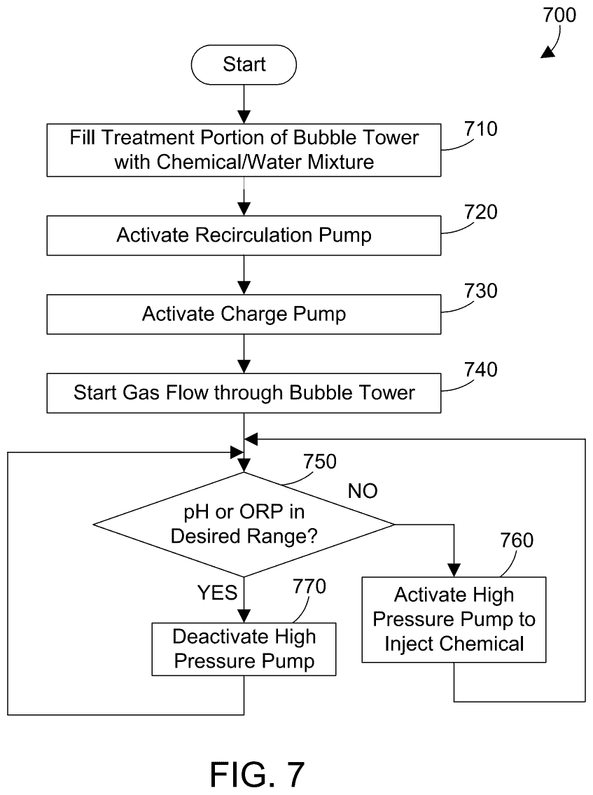

Referring to FIG. 7, a method 700 is preferably performed by the system controller 610 in FIG. 6. Fill the treatment portion of the bubble tower with the chemical/water mixture (step 710). As stated above, the preferred initial chemical/water mixture is 50% purified water and 50% of the pre-mixed oxidizing composition, but these proportions can vary according to several parameters, including the degree of H₂S contamination in the incoming gas stream. Activate the recirculation pump (step 720). Activate the charge pump (step 730). Start the gas flow through the bubble tower (step 740), which results in the gas bubbling from the gas inlet 684 through the chemical/water mixture 690 to the top of the bubble tower 680, where the cleaned gas is then exported via the gas outlet port 682. When the pH or ORP is not in the desired range (step 750=NO), activate the high pressure pump to inject the pre-mixed chemical in the tank 620 into the stream going into the chemical inlet 652 (step 760). When the pH or ORP is in the desired range (step 750=YES), deactivate the high pressure pump (step 770). Most bubble towers operate at relatively high pressures, some as high as 900 psi (6,200 kPa), which means the high pressure pump 630, tubing and fittings are preferably made from titanium or Hastelloy.

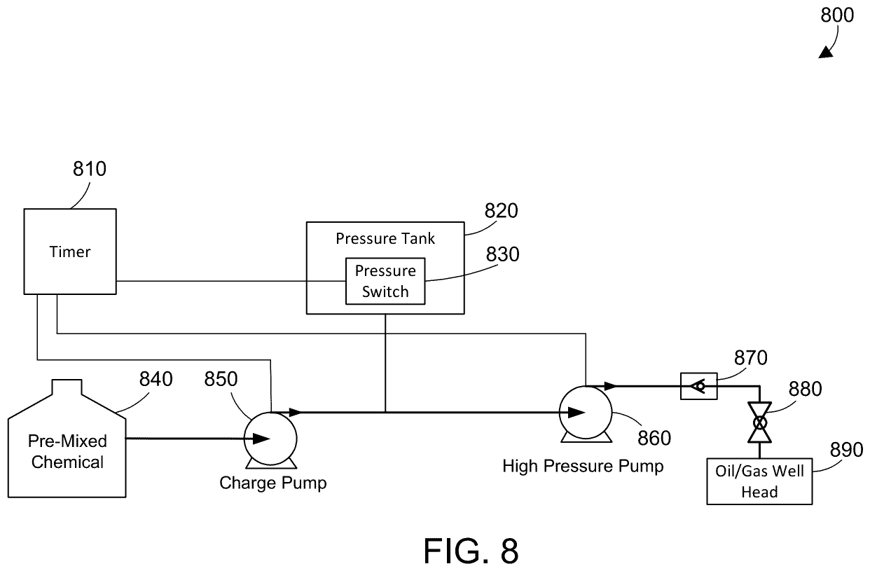

A third use case is to pump the oxidizing compositions disclosed herein into an oil or gas well to treat H₂S contamination at the well, even before the oil or gas goes into a pipeline. Referring to FIG. 8, an apparatus 800 includes a charge pump that pumps pre-mixed chemical from a tank 840 and outputs the pre-mixed chemical to the inlet of the high pressure pump 860. Tank 840 is preferably placed near the well head 890, and the tank 840 is preferably an opaque tank to prevent sunlight from contacting the pre-mixed chemical in the tank, since sunlight can accelerate the breakdown of the pre-mixed chemical. Tank 840 can be a relatively small tank, such as 30-100 gallons (110-380 liters) that can be filled once every few weeks with the pre-mixed chemical. In addition, the system 800 could optionally include a solar panel, battery, charge controller and power supply that provides power to the timer 810 and pumps 850 and 860 so no access is needed to line power in the remote location of the well head 890.

A pressure tank 820 is provided with a pressure switch 830 that is set at a minimum desired pressure value for the charge pump to maintain, such as 30 psi (210 kPa). Failure to maintain at least 30 psi (210 kPa) on the inlet of the high pressure pump 860 can result in the high pressure pump degassing and locking up. When the pressure switch 830 is activated due to low pressure on the output of the charge pump, the charge pump 850 is activated to increase the pressure. The activation of the charge pump can be until the pressure switch 830 changes state, or for some period of time after the pressure switch 830 changes state. The high pressure pump 860 is activated and deactivated by the timer 810 to deliver a desired quantity of the pre-mixed chemical 840 to the well head 890. This can be done by simply turning the high pressure pump on and off, or by varying the speed of the high pressure pump over time. In the alternative, the timer 810 could be omitted, with the rate of pumping by the charge pump 850 and high pressure pump 860 being set on the pumps themselves. When timer 810 is not present, a simple relay could be activated by the pressure switch 830 in the pressure tank 820 to cycle the charge pump 850 on and off as needed.

The output from the high pressure pump 860 runs through a check valve 870 then a ball valve 880 on top of the well head 890. Once the system 800 is installed and ready to run, the ball valve 880 is opened so the pre-mixed chemical can be injected into the well 890. Note the injection can be done at the top of the well or at the bottom of the well. Treatment at the top of an oil well can reduce H₂S, improve the separation of oil and water, and disinfect the oil from bacteria. Treatment at the bottom of an oil or gas well has been shown to reduce H₂S, reduce bacteria that produce H₂S, descale the pipes, and descale the geologic formation with the result of releasing additional oil or gas trapped behind the scale. The treatment of oil and gas wells with the SSH-100 oxidizing compositions has been shown to significantly improve the quantity of oil and/or gas production of the wells. The improvement has been so dramatic in some trials that treating wells with the oxidizing composition could effectively rehabilitate a failing well and convert it to a productive well.

The apparatus 800 is simpler than apparatus 100 because the two components of the chemical are pre-mixed, which eliminates the need for pH monitoring, an activator pump, and dynamic adjustment of the activator pump to achieve a mix of the appropriate pH. Note, however, the apparatus 100 could also be used at a well head within the scope of the disclosure and claims herein. In this configuration, the ball valve 880 on the well head 890 would be the chemical injection port 190 shown in FIG. 1, and atomization nozzles 192 would not be included.

For treatment at the top of an oil well, the preferred pH for the oxidizing composition is preferably 9.9 to 10.7, is more preferably 10.1 to 10.5, is most preferably 10.17 to 10.3, with a pH of 10.2 being optimal. For the treatment at the bottom of an oil well, the preferred pH for the oxidizing composition is preferably 9.7 to 10.7, is most preferably 9.9 to 10.5, with 10 being optimal. Using the apparatus 100 in FIG. 1, the oxidizing composition can be dynamically mixed to the desired pH. Using the apparatus 800 in FIG. 8, the pre-mixed chemical in tank 840 could have the desired pH, which can vary as described above depending on whether the top of the oil well or the bottom of the oil well is being treated.

Treatment at the bottom of an oil or gas well can require significant pressure because the well casing pressure on oil and gas wells can vary from 175-1,000 psi (1,200-6,900 kPa). This means the pressure provided by the high pressure pump 860 must be greater than the pressure in the well casing to inject the oxidizing composition down the well casing to the bottom of the well. Treatment at the bottom of an oil well is preferably done by treating the bottom of the well with a strong initial charge, followed by a smaller daily dosage.

Field testing for treatment at the bottom of an oil well used an initial dose of 50-100 gallons (190-380 liters) of the SH-100 oxidizing composition, followed by 10-15 gallons (39-57 liters) three times per week for six weeks. The dosing after the first six weeks should drop to 10-15 gallons (39-57 liters) per week to maintain a cleaner and better functioning oil well.

During months when the weather is cold the pre-mixed chemical in tank 840 could include an additive such as ethylene glycol or propylene glycol to lower the freezing point of the pre-mixed chemical. In the alternative, the freezing point of the sodium hypochlorite solution can be lowered by using a higher salt content in the sodium hypochlorite solution. The oxidizing compositions disclosed herein are most effect at temperatures above 0 degrees Fahrenheit (−18 degrees Celsius).

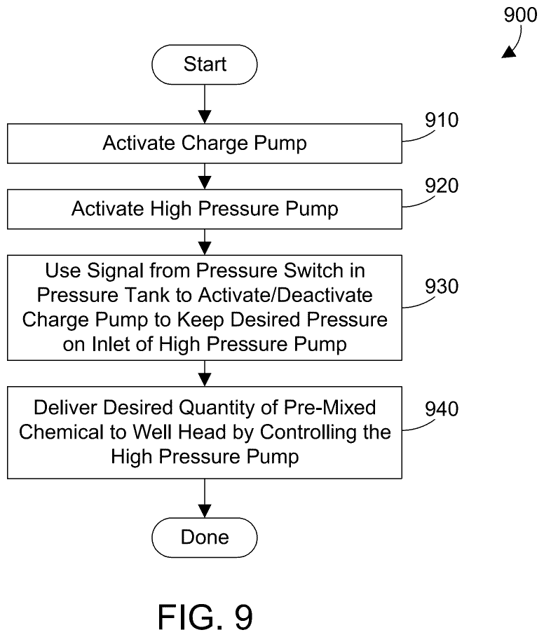

Referring to FIG. 9, a method 900 is preferably performed by the system 800 in FIG. 8. Activate the charge pump (step 910). Activate the high pressure pump (step 920). Use the signal from the pressure switch in the pressure tank to activate and deactivate the charge pump to keep the desired pressure on the inlet of the high pressure pump (step 930). Deliver the desired quantity of pre-mixed chemical to the well head by controlling the high pressure pump (step 940). Method 900 is then done. The controlling in step 940 can include activating the high pressure pump 860, deactivating the high pressure pump 860, and varying the speed of the high pressure pump 860. In some cases simply activating and deactivating the high pressure pump 860 is sufficient without a need to vary the speed of the high pressure pump 860.

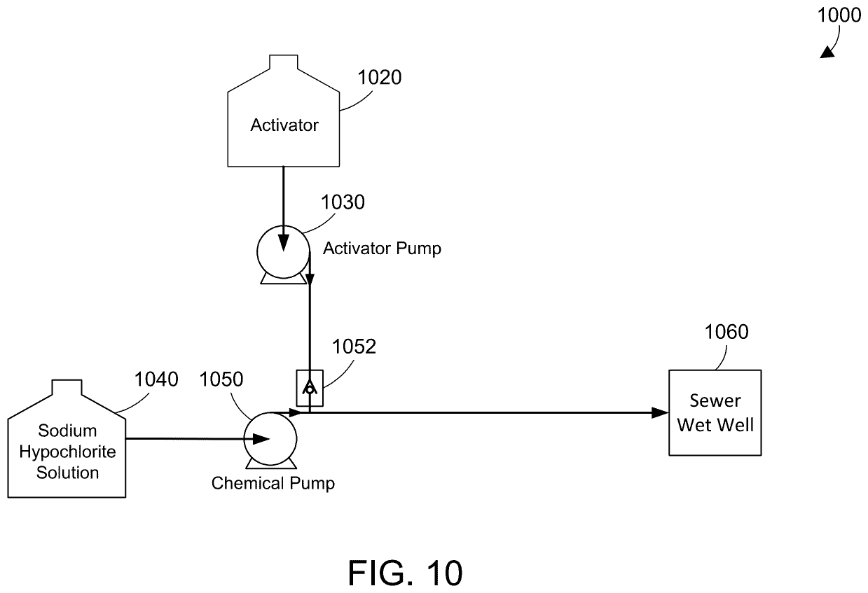

A fourth use case for the oxidizing compositions disclosed herein is to treat sewage in a sewer system to reduce undesirable odors, grease buildup and corrosion. Referring to FIG. 10, an apparatus 1000 includes a tank 1040 of sodium hypochlorite solution. A chemical pump 1050 pumps the sodium hypochlorite solution from tank 1040 to a sewer wet well 1060. An activator pump 1030 pumps activator from a tank 1020 and injects the activator through a check valve 1052 into the line connected to the outlet of the chemical pump 1050 to the sewer wet well 1060. In some implementations, the check valve 1052 could be omitted. The activator pump 1020 and chemical pump 1050 are set at fixed speeds to provide a desired ratio of sodium hypochlorite solution and activator such that the resulting mixture has a pH in a desired range. Note the resulting mixture being pumped into the sewer wet well is very diluted, typically 0.5%-3%, compared to the previous three use cases, which are typically 12%-15%. This is a low pressure system, so the activator pump 1030 and chemical pump 1050 can be inexpensive plastic chemical pumps, such as peristaltic pumps available from a number of different manufacturers, and the connections can be made via plastic tubing.

Treatment of a sewer system preferably starts at a sewer wet well and force main that are farthest from the sewage processing plant. H₂S production at the treated sewer wet well will be significantly reduced in a matter of hours. The force main connecting the treated sewer wet well will begin to produce less H₂S over the following week or two until the odor improvement is seen at the next sewer wet well in the line. Treatment can continue to determine how far each treatment extends in the sewer system. Once the distance for the treatment is determined, subsequent sewer wet wells can be treated in the same manner. The oxidizing compositions herein, especially SSH-100, will greatly reduce H₂S odor in sewer systems.

An alternative to system 1000 in FIG. 10 for treating a sewer wet well could use a pre-mixed oxidizing composition in tank 1040 and omit tank 1020, activator pump 1030, and check valve 1052. The result is a very simple system where the chemical pump 1050 slowly pumps the pre-mixed oxidizing composition from tank 1040 into the sewer wet well 1060. One advantage for using the system 1000 shown in FIG. 10 instead of the simplified system described above is the pH of a pre-mixed chemical will fall over time, while the pH of the sodium hypochlorite solution in tank 1040 and pH of the activator in tank 1020 is more stable over time.

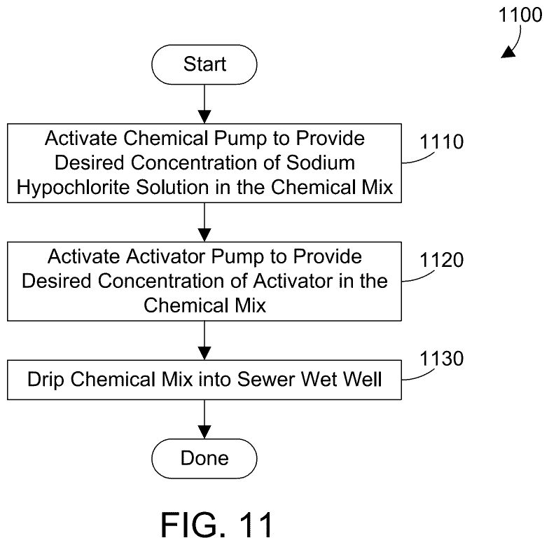

Referring to FIG. 11, a method 1100 is preferably performed by the system 1000 in FIG. 10. Activate the chemical pump to provide a desired concentration of sodium hypochlorite solution in the chemical mix (step 1110). Activate the activator pump to provide a desired concentration of activator in the chemical mix (step 1120). Drip the chemical mix into a sewer wet well (step 1130). Method 1100 is then done.

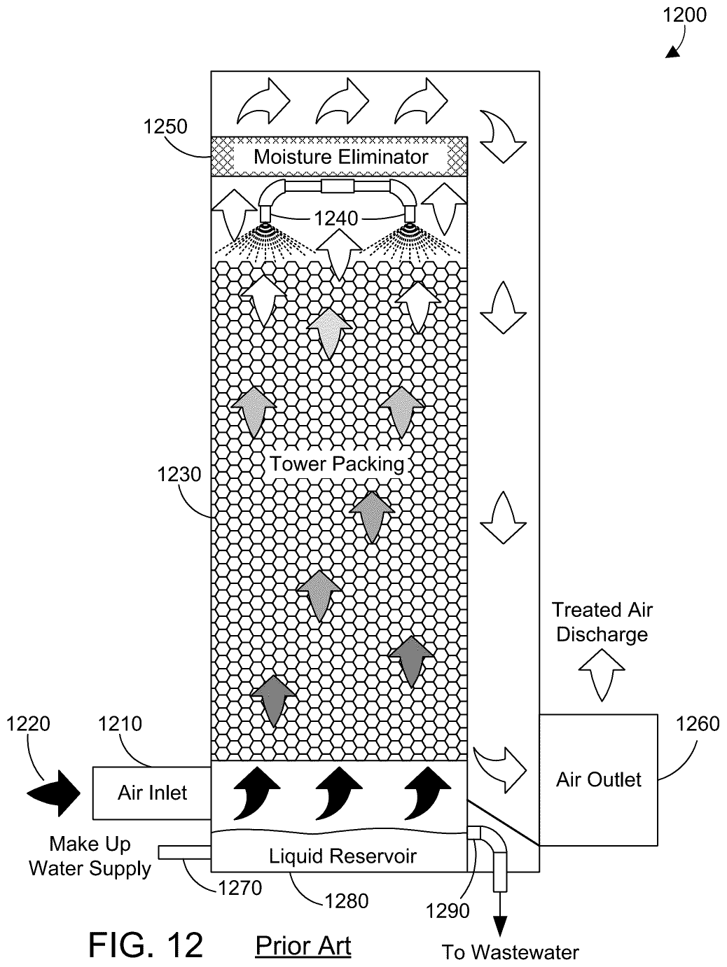

A fifth use case for the oxidizing compositions disclosed herein is in conjunction with a packed air scrubber. A prior art example of a packed air scrubber is shown at 1200 in FIG. 12. The air scrubber 1200 includes an upper portion that has one or more sprayers 1240 that spray a high volume of a liquid onto media referred to herein as tower packing 1230. A recirculation pump (not shown in FIG. 12) pumps liquid from the liquid reservoir 1280 to the sprayers 1240. The tower packing 1230 significantly increases the surface area of the liquid contacting air that passes through the tower packing, thereby significantly enhancing the ability of the air scrubber to purify the air. The liquid injected by sprayers 1240 preferably includes an oxidizer chemical that interacts with impurities in the air and scavenges the H₂S and other impurities from the air passing through the tower packing 1230, thereby purifying the air. Chlorine dioxide is one known oxidizing chemical used in prior art air scrubbers. The oxidizer chemical is typically injected into the line from the recirculation pump that supplies liquid to sprayers 1240. The lower portion 1280 of the packed air scrubber 1200 is a liquid reservoir. The liquid reservoir collects liquid dripping down through the tower packing 1230. An inlet 1270 to the liquid reservoir is coupled to a make up water supply. The make up water supply is simply a source of clean water, but the term “make up water supply” denotes that this source of clean water is providing what is known as “make up water” to the air scrubber. As the liquid passes through the tower packing and absorbs impurities, the ability of the liquid to further absorb impurities becomes reduced. The liquid reservoir includes liquid that can have a reduced effectiveness in air scrubbing over time. As a result, an overflow port 1290 is positioned at the top of the liquid reservoir 1280 so that as incoming clean water from the makeup water supply flows into to the inlet 1270, an amount of the liquid in the liquid reservoir flows out the overflow port 1290 to wastewater. The amount of water flowing from the make up water supply is set to an amount that will replace water lost by evaporation in the air scrubber 1200 and will additionally replace some of the liquid in the liquid reservoir 1280 at a controlled rate.

In FIG. 12, the color of the arrows indicating airflow indicates the impurities in the art. Thus, odor-laden (foul) air 1220 enters the air inlet 1210, which is shown as a black arrow to indicate foul air. The foul air 1220 flows over the liquid reservoir and starts its upward journey through the tower packing 1230. As the air traverses the tower packing, the impurities in the air (such as H₂S) are scavenged by the water and oxidizing chemical flowing down the tower packing 1230, as graphically represented by the black arrows at the bottom of the tower packing becoming lighter and lighter, until the arrows are white at the top of the tower packing 1230, indicating graphically the tower packing 1230 has done its job of scrubbing the impurities from the foul air. The air then passes through a moisture eliminator 1250, which removes all moisture from the air. The air then passes down the right side of the air scrubber 1200 to an air outlet 1260, where treated air is discharged. The air scrubber 1200 thus takes foul air 1220, scrubs it of impurities, pollutants and odors (also referred to herein as “contaminants”), and discharges clean air.

While the prior art air scrubber 1200 in theory turns foul air into clean air, in practice the known air scrubbers like 1200 in FIG. 12 remove some, but not all, of the contaminants. The goal is not to remove all the contaminants, but to clean the air sufficiently that the treated air can be discharged to the atmosphere without violating clean air regulations. Many known air scrubbers thus reduce contamination, but do not completely reduce odor in the treated air discharged from the air scrubber.

The three different oxidizing compounds disclosed herein may be used in the packed air scrubber use case described above, and selection of the preferred oxidizing composition will depend on the compounds to be scrubbed from the air.

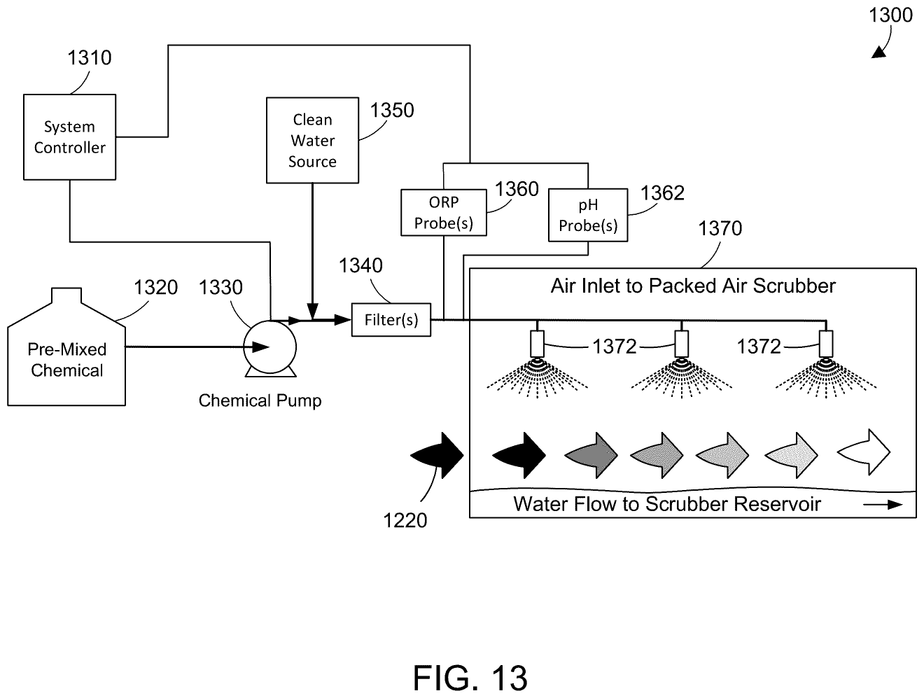

Referring to FIG. 13, an apparatus 1300 is a sixth use case for the oxidizing compositions disclosed herein to improve the performance of a packed air scrubber. We assume for this sixth use case a prior art scrubber 1200 as shown in FIG. 12 with the following modifications: 1) the make up water supply that is typically connected to the inlet 1270 is turned off or disconnected so no make up water enters the inlet; and 2) the air inlet includes atomization nozzles to pre-scrub the air entering the air scrubber. Referring again the FIG. 13, the apparatus 1300 is shown to include multiple atomization nozzles 1372 that spray an atomized mist over the foul air at the air inlet 1370 to the packed air scrubber. As the air passes from left to right through the air inlet to the packed air scrubber 1370 as shown in FIG. 13, two important things happen. First, the water/chemical mix being sprayed form the atomization nozzles 1372 cleans the air as it passes through the air inlet 1370, as graphically represented by the input air 1220 shown in black getting lighter and lighter as it travels along the length of the air inlet 1370. In FIG. 13, the black foul air 1220 becomes white, or nearly odorless, before the air even enters the air scrubber. Note, however, that the pre-treatment of the foul air in the air inlet 1370 may remove only some of the contaminants, while the air scrubber is then employed to remove additional contaminants. The second thing that happens as air flows through the air inlet 1370 is the water/chemical mix being sprayed from the atomization nozzles 1372 flows into the scrubber reservoir, as graphically represented as liquid at the bottom of the air inlet 1370 in FIG. 13 that flows to the right into the scrubber reservoir. The water/chemical mixture being sprayed from the atomization nozzles 1372 thus provide the quantity of make up water that would normally be input to the inlet 1270. Note the water/chemical mixture being sprayed from the atomization nozzles 1372 is continually being charged with new chemical, so the rate of input of the make up water from the atomization nozzles can be significantly less than the amount of make up water used in a prior art air scrubber.

The apparatus 1300 preferably includes a system controller 1310, a chemical pump 1330 that pumps a pre-mixed chemical from a tank 1320 and outputs the pre-mixed chemical to a pipe that also receives input from a clean water source 1350. The mixture of pre-mixed chemical and water then goes through one or more filters 1340 to the atomization nozzles 1372. The ORP probe(s) 1360 and pH probe(s) 1362 detect ORP and pH, respectively, of the water in the feed line supplying the chemical mixture to the atomization nozzles 1372. The optimum pH will be different depending on the odorants being scrubbed. The optimum ORP will preferably be greater than 500 millivolts.

An alternative to the apparatus of FIG. 13 for the sixth use case is to use the apparatus 100 shown in FIG. 1, with the atomization nozzles 192 representing the atomization nozzles 1372 in the air inlet 1370 in FIG. 13. The only other change required to apparatus 100 would be to provide a clean water source that provides a constant rate of makeup water to the output of the high pressure pump to the atomization nozzles 192.

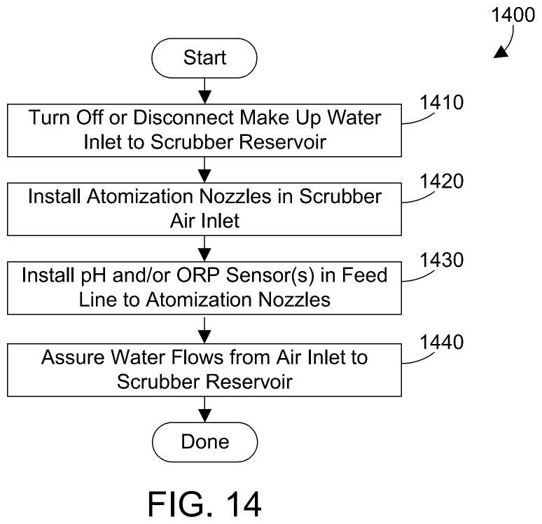

Referring to FIG. 14, a method 1400 is preferably performed to setup the apparatus 1300 to work with an air scrubber. Turn off or disconnect the source of make up water from the inlet to the scrubber reservoir (step 1410). Install atomization sprayers in the scrubber air inlet (step 1420). Install one or more pH and/or ORP sensors in the feed line to the atomization sprayers (step 1430). Assure the water that collects at the bottom of the air inlet from the atomization sprayers flows from the air inlet to the scrubber reservoir (step 1440). Method 1400 is then done.

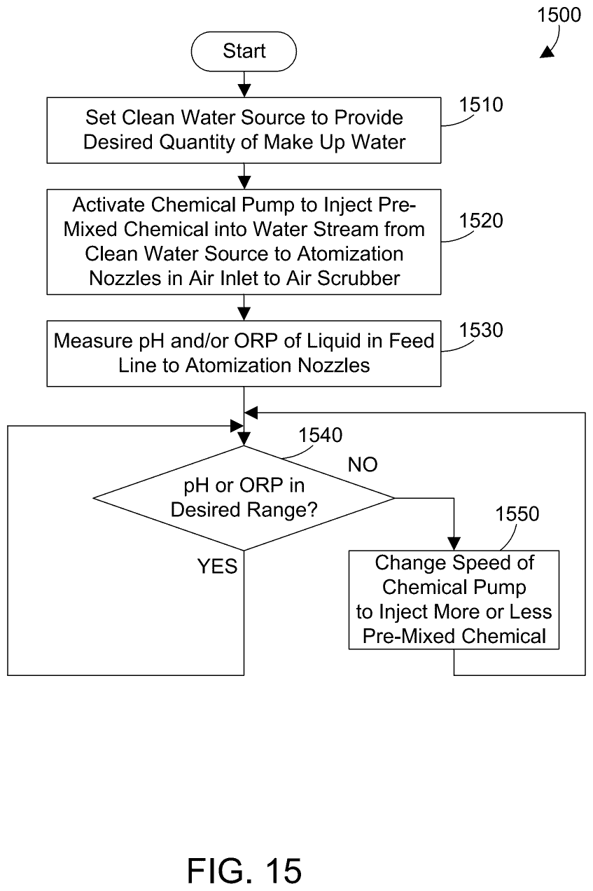

Referring to FIG. 15, a method 1500 is preferably performed by the system controller 1310 in FIG. 13. Set the clean water source to provide a desired quantity of make up water (step 1510). Activate the chemical pump to inject the pre-mixed chemical into the water stream from the clean water source to the atomization nozzles in the air inlet to the air scrubber (step 1520). Measure the pH and/or ORP of the liquid in the feed line to the atomization nozzles (step 1530). When the pH or ORP is not in the desired range (step 1540=NO), the speed of the chemical pump is changed to inject more or less of the pre-mixed chemical (step 1550) into the constant water stream from the clean water source in an attempt to bring the pH or ORP into the desired range. When the pH or ORP is in the desired range (step 1540=YES), method 1500 loops back to step 1540 to continue monitoring.

The result of pre-cleaning the air entering a packed air scrubber in the sixth use case is most of the odor in the air 1220 that passes through the air inlet to the air scrubber 1370 is removed before even entering the air scrubber, with the air scrubber simply removing any residual odor and removing the moisture before discharging the treated air at the air outlet.

While FIG. 12 shows a prior art vertical packed air scrubber, the apparatus and method of the seventh use case could also be used in the air inlet of a horizontal packed air scrubber within the scope of the disclosure and claims herein.

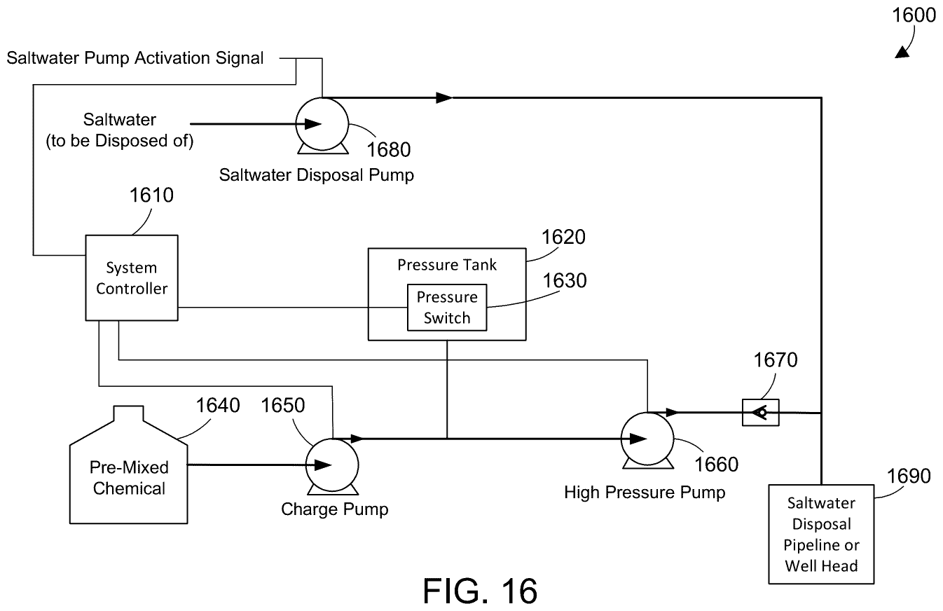

Referring to FIG. 16, an apparatus 1600 is a seventh use case for the oxidizing compositions disclosed herein to treat a saltwater disposal pipeline or well. Water separated from oil and gas is typically saltwater that must be disposed of. Many oil and gas fields include saltwater disposal wells to which the waste saltwater is pumped for disposal. An issue with saltwater disposal wells is their capacity lessens over time, and eventually the saltwater disposal well becomes unusable, requiring the drilling of new saltwater disposal wells. Testing has shown that treating saltwater disposal wells with the oxidizing compositions disclosed herein can clean and increase the capacity of the saltwater disposal well. In addition, treating pipelines that carry saltwater to saltwater disposal wells can remove scale and corrosion from the pipeline, which increases capacity of the pipeline. The seventh use case thus allow treating a saltwater disposal well right at the well itself, or treating a pipeline upstream from the saltwater disposal well, which will result in treatment of the pipeline at the point the oxidizing composition is injected into the pipeline, then flowing downstream in the pipeline and eventually to the saltwater disposal well itself. The treatment of a saltwater disposal pipeline can be miles away from the saltwater disposal well, and eventually over time the pipe will be cleaned until the oxidizing composition reaches the saltwater disposal well itself, thereby cleaning the well once the pipeline is clean.

In known saltwater disposal systems, a saltwater disposal pump moves waste saltwater through a saltwater disposal pipeline to the well head of a saltwater disposal well for disposal. The apparatus 1600 according to the seventh use case includes a saltwater disposal pump 1680 that pumps saltwater to be disposed of to the well head 1690 of a saltwater disposal well, thereby disposing of the saltwater. The apparatus 1600 injects one of the oxidizing compositions disclosed herein into the saltwater stream being pumped into the saltwater disposal well, thereby treating the well. A charge pump 1650 receives a pre-mixed chemical from a tank 1640, and outputs the pre-mixed chemical to the inlet of a high pressure pump 1660. The outlet of high pressure pump 1660 goes through a check valve 1670, which results in the pre-mixed chemical provided by the high pressure pump 1660 being injected into the saltwater stream being pumped into the well head 1690 of the saltwater disposal well. A pressure tank 1620 and pressure switch 1630 are used in a similar way as described with respect to the pressure tank 820 and pressure switch 830 in FIG. 8 to assure there is always 30-70 psi (210-489 kPa) on the outlet of the charge pump 1650 so the high pressure pump 1660 cannot become vapor-locked.

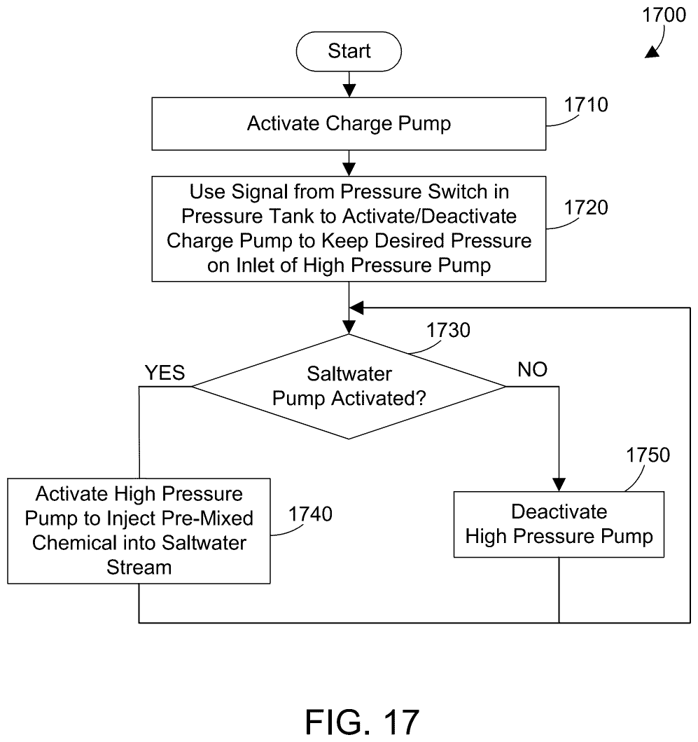

Referring to FIG. 17, a method 1700 is preferably performed by the system controller 1610 in FIG. 16. Activate the charge pump (step 1710). Use the signal from the pressure switch in the pressure tank to activate and deactivate the charge pump to keep a desired pressure on the inlet of the high pressure pump (step 1720). When the saltwater pump is activated (step 1730=YES), activate the high pressure pump to inject the pre-mixed chemical into the saltwater stream (step 1740). When the saltwater pump is not activated (step 1730=NO), the high pressure pump is deactivated (step 1750). The result is injecting the pre-mixed chemical into the saltwater while the saltwater is being pumped into the saltwater disposal well.

An alternative to using the apparatus 1600 for the seventh use case is to use apparatus 100 instead, with the chemical injection port(s) 190 pumping the oxidizing composition into the saltwater well. The treatment of a saltwater disposal well with one of the oxidizing compositions disclosed herein is preferably done by pumping the saltwater to the bottom of the saltwater well so the oxidizing compositions can do their work at the bottom of the well. It is expected that treating the top of the well with the oxidizing compositions would also have some benefit, but not as great as treating the bottom of the saltwater disposal well.

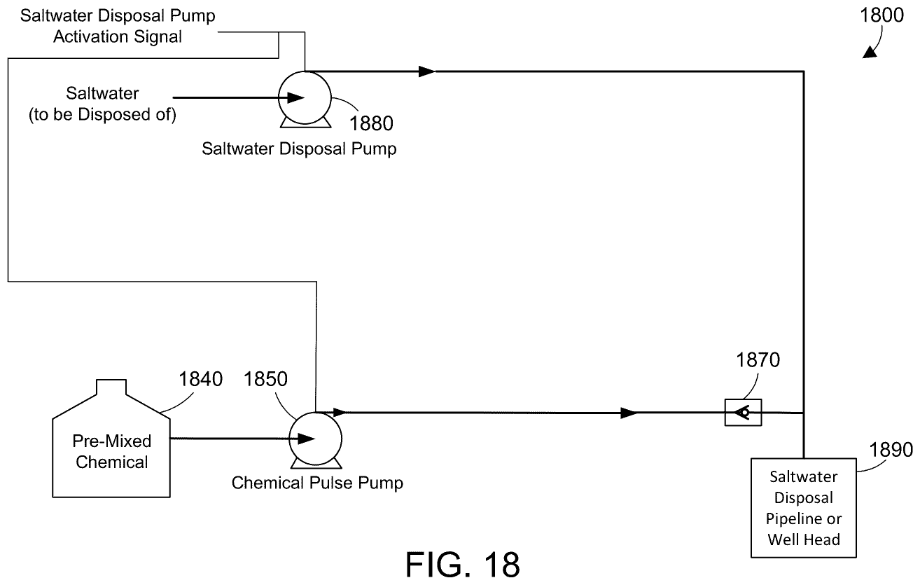

A simpler alternative to treating a saltwater disposal well with one of the oxidizing compositions disclosed herein is shown as apparatus 1800 shown in FIG. 18, which is suited for low pressure saltwater disposal wells. A chemical pulse pump 1850 pumps a pre-mixed chemical from a tank 1840 and the output of the chemical pulse pump passes through a check valve 1870 to inject the pre-mixed chemical into the saltwater stream being disposed of. The saltwater disposal pump activation signal that activates the saltwater disposal pump 1880 that pumps the saltwater to be disposed of is the same signal that activates the chemical pulse pump 1850. The result is each time the saltwater disposal pump 1880 is activated, the chemical pulse pump 1850 is also activated to inject the pre-mixed chemical into the saltwater stream being pumped through saltwater disposal pipeline or well head 1890 into the saltwater disposal well.

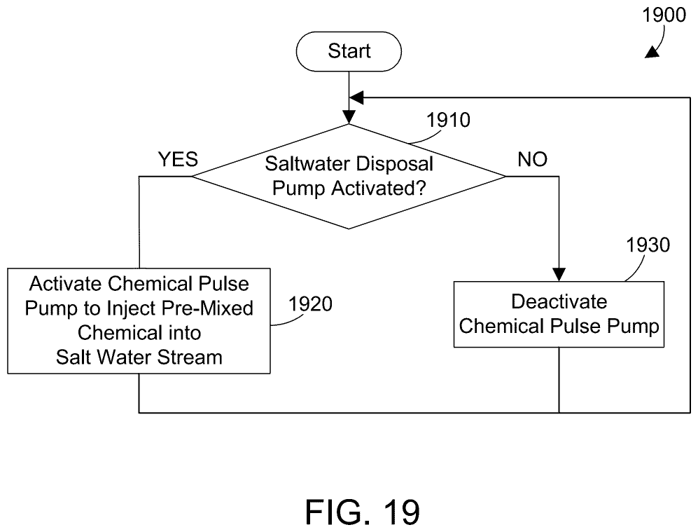

Referring to FIG. 19, a method 1900 is preferably performed by the apparatus 1800 in FIG. 18. When the saltwater disposal pump is activated (step 1910=YES), activate the chemical pulse pump to inject the pre-mixed chemical into the saltwater stream (step 1920). When the saltwater disposal pump is not activated (step 1910=NO), deactivate the chemical pulse pump (step 1930) so the pre-mixed chemical is no longer injected into the saltwater stream.

The preferred dosage for the treatment of saltwater disposal pipelines and wells is suitably 0.005-1.0 ml of pre-mixed oxidizing composition per 100 ml of saltwater being treated, and is most preferably 0.05-0.3 ml of pre-mixed oxidizing composition per 100 ml of saltwater being treated.

The treatment of a saltwater disposal well results in breaking down scale in the geologic formations of the well, which increases the well's capacity. Cleaning saltwater disposal wells according to the seventh use case allows continuing to use saltwater disposal wells, which saves the expense of drilling new wells when the old wells are so reduced in capacity that they are no longer useful. In one particular field test, a saltwater disposal well that had its capacity reduced to 400-500 barrels per day at high pressure was treated with one of the oxidizing compositions over a few months. The same well after treatment can now take over 5,000 barrels per day and could potentially go higher. A second saltwater disposal well was treated with an oxidizing composition, which doubled its capacity.

The system controllers 610 in FIG. 6, 1310 in FIG. 13, and 1610 in FIG. 16 are preferably similar to the system controller 110 shown in FIGS. 1-3 and described in detail above. Of course, other implementations for all of the system controllers 110, 610, 1310 and 1610 are also possible and are within the scope of the disclosure and claims herein.

Because the oxidizing compositions disclosed herein are new, there are numerous different possibilities for different use cases that have not yet been explored in detail. For example, the oxidizing compositions could be used to remove H₂S from petroleum products such as naphtha. Field testing showed good results in removing H₂S from naphtha using 1 ml of SSH-100 per 400 ml of naphtha, but good results could be expected by using a range of 0.01 to 8.0 ml of oxidizing composition per 400 ml of naphtha. Note the preferred oxidizing composition for H₂S removal for treating naphtha is SSH-100.

The oxidizing compositions could be used to treat landfill leachate and for odor control at landfills. The oxidizing compositions can be used as an emulsion breaker. The oxidizing compositions can be used as powerful disinfectants, even in a more diluted form, that would be very useful in disinfecting food-bearing surfaces and machines in food processing and food service industries. The oxidizing compositions herein work much faster than bleach and are more effective than bleach on a larger range of pathogens. The oxidizing compositions could be used to process wastewater in food processing facilities. The oxidizing compositions are such powerful oxidizers that they could be used instead of bleach in a paper production process. They could also be used to clean dirt, rocks and oil from drills used to drill oil or gas wells. The oxidizing compositions could also be used to break emulsion in oil so the fluids in the oil are easier to separate from the oil. The oxidizing compositions could also be used to reduce odor emissions from smokestacks.

While some of the use cases above, including those in FIGS. 8, 13, 16 and 18 are shown using a pre-mixed chemical, it is also within the scope of these use cases to dynamically mix the sodium hypochlorite solution and activator as shown in FIG. 1. These and other variations are within the scope of the disclosure and claims herein.

While specific materials and chemicals are discussed herein by way of example, one skilled in the art will recognize that different materials and chemicals could be used for different applications. The disclosure and claims herein expressly extend to any suitable materials and chemicals, whether currently known or developed in the future.

Many of the units herein are expressed in both imperial and metric forms, with the preferred specified and the equivalent in parentheses.

The disclosure and claims herein support a method for treating a sewer wet well comprising: providing an aqueous oxidizer composition in a first tank; providing an aqueous activator composition in a second tank; pumping the aqueous oxidizer composition into a first pipe at a first pressure; and pumping the aqueous activator composition into the first pipe at a second pressure greater than the first pressure to inject the aqueous activator composition into the first pipe, thereby creating an oxidizing composition in the first pipe, wherein the first pipe carries the oxidizing composition into the sewer wet well.

The disclosure and claims herein further support a method for treating a sewer wet well comprising: providing a pre-mixed oxidizing composition in a first tank, wherein the pre-mixed oxidizing composition comprises mixture products of water, sodium hypochlorite, a chelating agent, and a transition metal compound; and pumping the pre-mixed oxidizing composition into the sewer wet well at a predetermined rate.

The disclosure and claims herein additionally support an apparatus comprising: a first tank for holding an aqueous oxidizer composition that has a pH that is substantially basic; a second tank for holding an aqueous activator composition that has a pH that is substantially acidic; a first pump that pumps the aqueous oxidizer composition from the first tank to a first pipe at a first pressure; a second pump that pumps the aqueous activator composition from the second tank to the first pipe at a second pressure higher than the first pressure to inject the aqueous activator composition into the first pipe, thereby creating an oxidizing composition in the first pipe; and an output coupled to the first pipe that distributes the oxidizing composition to a sewer wet well.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. A method for treating a sewer wet well comprising:
providing an aqueous oxidizer composition in a first tank;
providing an aqueous activator composition in a second tank;
pumping the aqueous oxidizer composition into a first pipe at a first pressure; and
pumping the aqueous activator composition into the first pipe at a second pressure greater than the first pressure to inject the aqueous activator composition into the first pipe, thereby creating an oxidizing composition in the first pipe, wherein the first pipe carries the oxidizing composition into the sewer wet well.

2. The method of claim 1 wherein the aqueous oxidizer composition comprises a sodium hypochlorite solution.

3. The method of claim 2 wherein the sodium hypochlorite solution has a concentration of 0.5-3%.

4. The method of claim 1 wherein the aqueous activator composition comprises a chelating agent and a transition metal compound.

5. The method of claim 4 wherein the chelating agent comprises etidronic acid.

6. The method of claim 4 wherein the transition metal compound comprises an iron compound.

7. The method of claim 1 wherein pH of the oxidizing composition is 9.0 to 10.1.

8. The method of claim 1 wherein pH of the oxidizing composition is 9.6 to 10.0.

9. The method of claim 1 wherein pH of the oxidizing composition is about 9.7.

10. A method for treating a sewer wet well comprising:
providing a pre-mixed oxidizing composition in a first tank, wherein the pre-mixed oxidizing composition comprises mixture products of water, sodium hypochlorite, a chelating agent, and a transition metal compound; and
pumping the pre-mixed oxidizing composition into the sewer wet well at a predetermined rate.

11. The method of claim 10 wherein pH of the pre-mixed oxidizing composition is 9.0 to 10.1.

12. The method of claim 10 wherein pH of the pre-mixed oxidizing composition is 9.6 to 10.0.

13. The method of claim 10 wherein pH of the pre-mixed oxidizing composition is about 9.7.

14. An apparatus comprising:
a first tank for holding an aqueous oxidizer composition that has a pH that is substantially basic;
a second tank for holding an aqueous activator composition that has a pH that is substantially acidic;
a first pump that pumps the aqueous oxidizer composition from the first tank to a first pipe at a first pressure;
a second pump that pumps the aqueous activator composition from the second tank to the first pipe at a second pressure higher than the first pressure to inject the aqueous activator composition into the first pipe, thereby creating an oxidizing composition in the first pipe; and
an output coupled to the first pipe that distributes the oxidizing composition to a sewer wet well.

15. The apparatus of claim 14 wherein the aqueous oxidizer composition comprises a sodium hypochlorite solution.

16. The apparatus of claim 15 wherein the sodium hypochlorite solution has a concentration of 0.5-3%.

17. The apparatus of claim 14 wherein the aqueous activator composition comprises a chelating agent and a transition metal compound.

18. The apparatus of claim 17 wherein the chelating agent comprises etidronic acid.

19. The apparatus of claim 17 wherein the transition metal compound comprises an iron compound.
